(19) United States
(12) Patent Application Publication
(10) Pub. No.: US 2025/0168648 A1
(43) Pub. Date: May 22, 2025

(54) ELECTRONIC DEVICE AND METHOD FOR WIRELESS COMMUNICATION, AND COMPUTER READABLE STORAGE MEDIUM

(71) Applicant: Sony Group Corporation, Tokyo (JP)

(72) Inventors: Zhiyang CHENG, Beijing (CN); Youping ZHAO, Beijing (CN); Shuo WANG, Beijing (CN); Chen SUN, Beijing (CN)

(73) Assignee: Sony Group Corporation, Tokyo (JP)

(21) Appl. No.: 18/841,703

(22) PCT Filed: Apr. 10, 2023
(86) PCT No.: PCT/CN2023/087241

§ 371 Date: Aug. 27, 2024

(30) Foreign Application Priority Data
Apr. 15, 2022 (CN) 202210396173.4

(51) Int. Cl. H04W 16/10; H04W 24/10; H04W 60/00; H04W 64/00; H04W 72/0453

(52) U.S. Cl. CPC H04W 16/10; H04W 24/10; H04W 60/00; H04W 64/00; H04W 72/0453

(57) ABSTRACT

The present disclosure provides an electronic device and a method for wireless communication, and a computer readable storage medium. The electronic device comprises a processing circuit, configured to: in response to a transaction endorsement request from a buyer node of a transaction for wireless resources, calculate a transaction characteristic of the transaction on the basis of an interference impact that the transaction will have on cumulative interference suffered by a host system and a performance impact on network performance; generate a transaction endorsement response at least on the basis of the transaction characteristic; and send the transaction endorsement response to the buyer node.

This application claims the priority level to Chinese Patent Application No. 202210396173.4, titled “ELECTRONIC DEVICE AND METHOD FOR WIRELESS COMMUNICATION, AND COMPUTER READABLE STORAGE MEDIUM”, filed on Apr. 15, 2022 with the China National Intellectual Property Administration (CNIPA), which is incorporated herein by reference in its entirety.

### FIELD

Embodiments of the present disclosure generally relate to the field of wireless communications, in particular to management technologies for transactions of wireless resources, and more specifically, to an electronic apparatus and a method for wireless communications, and a computer-readable storage medium.

### BACKGROUND

Blockchain is widely studied due to its characteristics of distributed storage, decentralization, high security, openness and transparency. Blockchain-based spectrum management technology can effectively solve the security risks caused by centralized spectrum management. In recent years, the blockchain-based spectrum management technology has been widely studied internationally. Consensus mechanisms, smart contracts and other technologies are hot research topics in blockchain spectrum management technology. However, for spectrum blockchain, current research on queuing mechanisms for blockchain transactions is still in its infancy. For various application scenarios of fifth-generation mobile communications and even sixth-generation mobile communications, such as eMBB, URLLC, mMTC, etc., a service type of spectrum transaction may change, and therefore spectrum transaction needs to be designed accordingly.

In a citizen broadband radio service (CBRS) system, interferences to a primary system needs to be considered when a secondary system utilizes the spectrum resources. Therefore, protection of a communication quality of the primary system needs to be considered in spectrum transaction. Therefore, it is expected to design a blockchain queuing mechanism for spectrum management in combination with an actual situation of a wireless communication system.

### SUMMARY

In the following, an overview of the present disclosure is given simply to provide basic understanding to some aspects of the present disclosure. It should be understood that this overview is not an exhaustive overview of the present disclosure. It is not intended to determine a critical part or an important part of the present disclosure, nor to limit the scope of the present disclosure. An object of the overview is only to give some concepts in a simplified manner, which serves as a preface of a more detailed description described later.

According to an aspect of the present disclosure, an electronic apparatus for wireless communications is provided. The electronic apparatus includes processing circuitry, configured to: calculate, in response to a transaction endorsement request from a buyer node of a transaction for wireless resources, a transaction feature of the transaction based on an interference impact on accumulated interferences a primary system is subjected to and a performance impact on network performance to be produced by the transaction; generate, at least based on the transaction feature, a transaction endorsement response; and transmit the transaction endorsement response to the buyer node.

According to another aspect of the present disclosure, a method for wireless communications is provided, including: calculating, in response to a transaction endorsement request from a buyer node of a transaction for wireless resources, a transaction feature of the transaction based on an interference impact on accumulated interferences a primary system is subjected to and a performance impact on network performance to be produced by the transaction; generating, at least based on the transaction feature, a transaction endorsement response; and transmitting the transaction endorsement response to the buyer node.

According to the electronic apparatus and method in the above aspects in the present disclosure, the transaction feature considering both the interference impact and the performance impact is generated for the transaction for wireless resources. Hence, in management of transactions for wireless resources, protection of the primary system can be improved while a transaction processing efficiency and a resource utilization efficiency can be improved.

According to an aspect of the present disclosure, an electronic apparatus for wireless communications is provided. The electronic apparatus includes processing circuitry, configured to: generate a transaction endorsement request for a transaction of wireless resources; transmit the transaction endorsement request to a spectrum management device; and receive, from the spectrum management device, a transaction endorsement response to the transaction endorsement request, where the transaction endorsement response includes a transaction feature of the transaction, and the transaction feature is calculated by the spectrum management device based on an interference impact on accumulated interferences a primary system is subjected to and a performance impact on network performance to be produced by the transaction.

According to another aspect of the present disclosure, a method for wireless communications is provided, including: generating a transaction endorsement request for a transaction of wireless resources; transmitting the transaction endorsement request to a spectrum management device; and receiving, from the spectrum management device, a transaction endorsement response to the transaction endorsement request, where the transaction endorsement response includes a transaction feature of the transaction, and the transaction feature is calculated by the spectrum management device based on an interference impact on accumulated interferences a primary system is subjected to and a performance impact on network performance to be produced by the transaction.

According to the electronic apparatus and method in the above aspects in the present disclosure, the transaction of wireless resources is performed based on the transaction feature that considers both the interference impact and the performance impact. Hence, in management of transactions for wireless resources, protection of the primary system can be improved while a transaction processing efficiency and a resource utilization efficiency can be improved.

According to an aspect of the present disclosure, an electronic apparatus for wireless communications is provided. The electronic apparatus includes processing circuitry, configured to: receive an endorsed transaction for wireless resources which includes a transaction feature of the transaction, the transaction feature being calculated by a spectrum management device based on an interference impact on accumulated interferences a primary system is subjected to and a performance impact on network performance to be produced by the transaction; and add the received transaction as a new transaction into a transaction pool maintained based on a blockchain technology.

According to another aspect of the present disclosure, a method for wireless communications is provided, including: receiving an endorsed transaction for wireless resources which includes a transaction feature of the transaction, the transaction feature being calculated by a spectrum management device based on an interference impact on accumulated interferences a primary system is subjected to and a performance impact on network performance to be produced by the transaction; and adding the received transaction as a new transaction into a transaction pool maintained based on a blockchain technology.

According to the electronic apparatus and method in the above aspects in the present disclosure, the transaction for wireless resources is performed based on the transaction feature that considers both the interference impact and the performance impact and by using the blockchain technology. Hence, management of transactions for wireless resources is realized in a distributed manner, the protection of the primary system can be improved, while the transaction processing efficiency and the resource utilization efficiency can be improved.

According to an aspect of the present disclosure, an electronic apparatus for wireless communications is provided. The electronic apparatus includes processing circuitry, configured to: receive an interference validation request from a coexistence manager, the interference validation request including at least part information in a transaction endorsement request of a buyer node of a transaction for wireless resources; calculate, in response to the interference validation request, an interference impact to be produced by the transaction on accumulated interferences a primary system is subjected to, and generate an interference validation response based on the interference impact; and transmit the interference validation response to the coexistence manager.

According to another aspect of the present disclosure, a method for wireless communications is provided, including: receiving an interference validation request from a coexistence manager, the interference validation request including at least part information in a transaction endorsement request of a buyer node of a transaction for wireless resources; calculating, in response to the interference validation request, an interference impact to be produced by the transaction on accumulated interferences a primary system is subjected to, and generating an interference validation response based on the interference impact; and transmitting the interference validation response to the coexistence manager.

According to the electronic apparatus and method in the above aspects in the present disclosure, the impact to be produced by the transaction for wireless resources on the accumulated interferences the primary system is subjected to is calculated, so that the protection of the primary system is realized effectively.

According to other aspects of the present disclosure, a computer program code and a computer program product for implementing the method for wireless communications mentioned above, and a computer-readable storage medium having the computer program code for implementing the method for wireless communications stored thereon are provided.

These and other advantages of the present disclosure will be more apparent from the following detailed description of preferred embodiments of the present disclosure in conjunction with the accompanying drawings.

### BRIEF DESCRIPTION OF THE DRAWINGS

To further set forth the above and other advantages and features of the present disclosure, detailed description will be made in the following taken in conjunction with accompanying drawings in which identical or like reference signs designate identical or like components. The accompanying drawings, together with the detailed description below, are incorporated into and form a part of the specification. It should be noted that the accompanying drawings only illustrate, by way of example, typical embodiments of the present disclosure and should not be construed as a limitation to the scope of the disclosure. In the accompanying drawings:

FIG. 1 shows a schematic diagram of a CBRS system scenario as an example;

FIG. 2 shows a functional block diagram of an electronic apparatus for wireless communications according to an embodiment of the present disclosure;

FIG. 3 shows a schematic diagram of changes in interferences produced by a transaction for wireless resources to the primary system;

FIG. 4 shows a schematic diagram of an information flow among a CBSD serving as a buyer node, an SAS and a CxM;

FIG. 5 shows a functional block diagram of an electronic apparatus for wireless communications according to another embodiment of the present disclosure;

FIG. 6 shows a functional block diagram of an electronic apparatus for wireless communications according to another embodiment of the present disclosure;

FIG. 7 shows an example of an information flow among different CBSDs;

FIG. 8 shows a functional block diagram of an electronic apparatus for wireless communications according to another embodiment of the present disclosure;

FIG. 9 shows a schematic diagram of a relevant information flow for transaction management based on blockchain;

FIG. 10 shows a general schematic diagram of a transaction pooling process;

FIG. 11 schematically shows a schematic diagram of selecting transactions from among transaction queues and generating new blocks;

FIG. 12 shows a flowchart of a method for wireless communications according to an embodiment of the present disclosure;

FIG. 13 shows a flowchart of a method for wireless communications according to another embodiment of the present disclosure;

FIG. 14 shows a flowchart of a method for wireless communications according to another embodiment of the present disclosure;

FIG. 15 shows a flowchart of a method for wireless communications according to another embodiment of the present disclosure;

FIG. 16 shows an example of a simulation parameter configuration;

FIG. 17 shows a schematic diagram of randomly distributed CBSDs;

FIG. 18 shows a utility function of an impact on accumulated interferences of a primary system;

FIG. 19 shows a utility function of a bandwidth;

FIG. 20 shows a utility function of a transmission power difference;

FIG. 21 shows a utility function of a transaction queuing time;

FIG. 22 shows a change of a transaction feature update function relative to a queuing time under different parameter values;

FIG. 23 shows a schematic diagram of a transaction fee-based queuing method;

FIG. 24 shows a schematic diagram of a FCFS-based queuing method;

FIG. 25 shows a graph of an impact on accumulated interferences of a primary system produced by a transaction for wireless resources under different queuing methods;

FIG. 26 shows a graph of an impact on accumulated interferences of a primary system produced by a transaction for wireless resources under different queuing methods;

FIG. 27 shows a graph of a cumulative distribution of a queuing time for an important transaction under different queuing methods;

FIG. 28 shows a graph of a cumulative distribution of a queuing time for all transactions under different queuing methods;

FIG. 29 shows a graph of a cumulative distribution of node satisfaction degree under different queuing methods;

FIG. 30 shows a graph showing a cumulative distribution of an important transaction loss rate under different queuing methods;

FIG. 31 is a block diagram showing an example of a schematic configuration of a server;

FIG. 32 is a block diagram showing a first example of an exemplary configuration of an eNB or gNB to which the technology of the present disclosure may be applied;

FIG. 33 is a block diagram showing a second example of an exemplary configuration of an eNB or gNB to which the technology of the present disclosure may be applied; and

FIG. 34 is a block diagram of an exemplary block diagram illustrating the structure of a general purpose personal computer capable of realizing the method and/or device and/or system according to the embodiments of the present disclosure.

### DETAILED DESCRIPTION

An exemplary embodiment of the present disclosure will be described hereinafter in conjunction with the accompanying drawings. For the purpose of conciseness and clarity, not all features of an embodiment are described in this specification. However, it should be understood that multiple decisions specific to the embodiment have to be made in a process of developing any such embodiment to realize a particular object of a developer, for example, conforming to those constraints related to a system and a service, and these constraints may change as the embodiments differs. Furthermore, it should also be understood that although the development work may be very complicated and time-consuming, for those skilled in the art benefiting from the present disclosure, such development work is only a routine task.

Here, it should also be noted that in order to avoid obscuring the present disclosure due to unnecessary details, only a device structure and/or processing steps closely related to the solution according to the present disclosure are illustrated in the accompanying drawing, and other details having little relationship to the present disclosure are omitted.

### First Embodiment

As mentioned before, in the blockchain queuing mechanism for spectrum management, it is expected to consider the actual situation of the wireless communication system. The blockchain queuing mechanism for spectrum management uses the blockchain technology to manage spectrum transactions occurred in the network, such as sorting transactions by their priority levels to determine which transaction or transactions are to be processed first. To this end, a transaction feature is provided in this embodiment to assess a priority level or importance of a wireless resource transaction comprehensively and accurately. The wireless resource transaction includes, for example, a spectrum transaction and/or a power transaction, which are not limited.

In addition, although the embodiment of the present disclosure is proposed using the blockchain queuing mechanism for spectrum management as an example of an application scenario, the application of the embodiment of the present disclosure is not limited thereto. Instead, the embodiment of the present disclosure can be applied to any scenario in which assessment of a priority level or importance of a transaction for wireless resources is required.

To facilitate understanding, FIG. 1 shows a schematic diagram of a CBRS system scenario as an example. This scenario includes a primary system and a secondary system. The primary system is generally a military radar system, a ground satellite station, and the like for example. The secondary system is mainly a citizens broadband radio service device (CBSD), that is, a CBRS base station. Since radio propagation may interfere with non-target receivers, the CBSD may interfere with the primary system, and potential interferences exist between different CBSDs. A spectrum access system (SAS) has information of a protection point of the primary system and is responsible for protecting a communication quality of the primary system. Each coexistence manager (CxM) is responsible for allocation of CBSD spectrum resources and coexistence between CBSDs in a coexistence group (CxG), and is required to obey instructions initiated by the SAS for protection of the primary system. The CxM and the CBSD can exchange information with each other through the SAS-CBSD protocol.

Assuming that each CBSD in the scenario is allocated with initial wireless resources (such as spectrum resources and transmission power), a CBSD may initiate a wireless resource transaction in a case that the CBSD needs additional wireless resources. Multiple wireless resource transactions may exist in the network at the same time. Due to a limited processing capability, the transactions need to be processed in a certain order. In this case, how to determine the priority levels for respective transactions, that is, in what order the transactions are processed, would have a significant impact on the network performance.

In an example, blockchain technology may be employed for distributed processing of the transactions. For example, at least some of the CBSDs in the network serve as transaction processing nodes in a blockchain. Each transaction processing node maintains a transaction pool of itself and sorts the transactions, such as in a descending order of priority levels. At an instant for new block generation, a CBSD which obtains the block generation authorization packages the transactions in the transaction pool to generate a new block. The new block includes, for example, several top-ranked transactions. This new block is transmitted to all blockchain nodes, the CxM and the SAS, for synchronization.

In the following, description is made with reference to the system scenario shown in FIG. 1. However, it should be understood that this is not limiting.

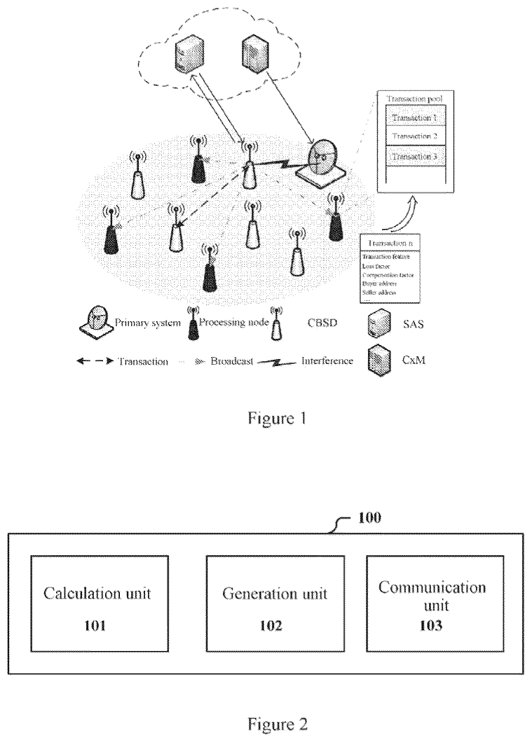

FIG. 2 shows a functional block diagram of an electronic apparatus 100 for wireless communications according to an embodiment of the present disclosure. As shown in FIG. 2, the electronic apparatus 100 includes: a calculation unit 101, configured to calculate, in response to a transaction endorsement request from a buyer node of a transaction for wireless resources, a transaction feature of the transaction based on an interference impact on accumulated interferences a primary system is subjected to and a performance impact on network performance to be produced by the transaction; a generation unit 102, configured to generate, at least based on the transaction feature, a transaction endorsement response; and a communication unit 103, configured to transmit the transaction endorsement response to the buyer node.

The calculation unit 101, the generation unit 102 and the communication unit 103 may be implemented by one or more processing circuitries, which may be implemented as a chip or a processor, for example. Moreover, it should be understood that various functional units in the electronic apparatus shown in FIG. 2 are only logical modules divided based on their specific functions, and are not intended to limit a specific implementation.

The electronic apparatus 100 may, for example, be provided on or communicatively connected to the CxM. The buyer node is a CBSD, for example.

Here, it should be noted that the electronic apparatus 100 may be implemented in a chip level or in an apparatus level. For example, the electronic apparatus 100 may operate as the CxM itself and may further include external devices such as a memory, and a transceiver (not shown). The memory may be used to store related data information and programs that the electronic apparatus needs to execute to achieve various functions. The transceiver may include one or more communication interfaces to support communication with different devices (such as another CxM, SAS, CBSD or the like). An implementation of the transceiver is not specifically limited here.

In this embodiment, the transaction feature is calculated based on both the interference impact on accumulated interferences a primary system is subjected to and the performance impact on network performance to be produced by the transaction. The transaction feature, for example, represents a priority level for processing the transaction or the importance of the transaction.

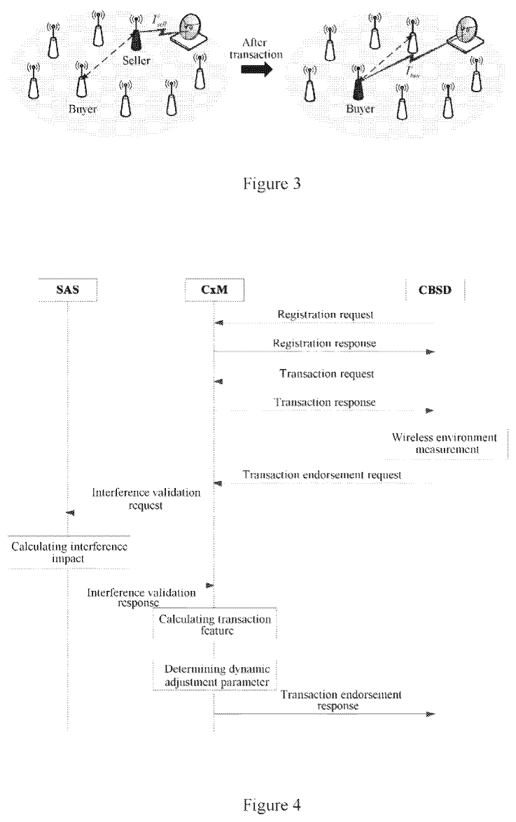

FIG. 3 shows a schematic diagram of changes in interferences caused by a wireless resource transaction to a primary system. It is understandable that a transaction for wireless resources may cause an impact on accumulated interferences a primary system is subjected to. Since a secondary system needs to work on a premise that a communication quality of the primary system is ensured, the impact on the accumulated interferences a primary system is subjected to needs to be considered in a processing of the transaction. In addition, a transaction volume involved in the transaction reflects the magnitude of a transaction demand, which in turn reflects a degree of the impact on network performance. Therefore, the transaction feature that takes both the two impacts into consideration can accurately reflect a comprehensive impact on the network to be produced by the transaction, and thus can be used to evaluate the priority level or importance of the transaction.

For ease of understanding, FIG. 4 shows a schematic diagram of an information flow among a CBSD serving as a buyer node, an SAS, and a CxM. It should be noted that only one CBSD is shown here as an example, but this is not limiting, and multiple CBSDs may exist in practice.

As shown in FIG. 4, initially, the communication unit 103 is further configured to receive a registration request from a transaction node and transmit a registration response to the transaction node. The registration request includes, for example, an indication that the transaction node supports a wireless resource transaction function and/or that the transaction node supports a wireless resource transaction processing function. In a case that the registration request includes an indication that the transaction node supports a wireless resource transaction function, the CxM learns, for example, that the transaction node supports a blockchain transaction function. In a case that the registration request includes an indication that the transaction node supports a wireless resource transaction processing function, the CxM learns that the transaction node supports a blockchain transaction processing function. Any CBSD with the blockchain transaction function can perform a spectrum transaction, and the CBSD with the blockchain transaction processing function can package and process a transaction. Specific processes thereof are described in detail later.

In addition, before receiving the transaction endorsement request from the buyer node, the communication unit 103 further receives a transaction request from the buyer node. In response to the transaction request, the generation unit 102 queries for wireless resources and seller node available for transaction. The communication unit 103 transmits information of the wireless resources and seller node available for transaction to the buyer node as a transaction response. The queried seller node and the buyer node belong to the same blockchain, and the transaction request indicates that seller information needs to be queried for. For example, the transaction request may include a transaction type and/or a service type. The transaction type includes information indicating a type of wireless resources for the transaction. For example, the transaction type includes one or more of the following: bandwidth, and power. The service type includes, for example, information indicating different service scenarios. The service scenarios include, for example, eMBB, URLLC, mMTC, and the like. Different service types may further correspond to different transaction types. For example, the eMBB corresponds to the bandwidth, the mMTC corresponds to the power, and the like.

After receiving the transaction response, the buyer node performs a wireless environment measurement related to the transaction type based on the transaction response, for example, measuring interferences, an available frequency band, the number of users, and the like. Subsequently, the buyer node may generate a transaction endorsement request for the transaction at least based on a measurement result, and transmit the transaction endorsement request to the CxM, so that the CxM (and the SAS) endorse the transaction. Besides validating basic information of the buyer node, an endorsement process further includes calculating the transaction feature.

The transaction endorsement request includes, for example, one or more of the following: basic information of the buyer node, a measurement report of a wireless environment measurement performed by the buyer node for the transaction, an expected transmission parameter of the buyer node, a transmission parameter of a seller node, a geographical location of the buyer node, a geographical location of the seller node, a transaction frequency band, a transaction type, a transaction volume and a service type. Information in the transaction endorsement request is used for determining the transaction feature of the transaction.

In an example, the communication unit 103 is further configured to: transmit an interference validation request to the SAS, so that the SAS calculates the interference impact based on the interference validation request; and receive an interference validation response from the SAS. The interference validation request includes at least part information in the transaction endorsement response, and the interference validation response includes information of the calculated interference impact. For example, the interference validation request may include a transmission parameter, a transaction frequency band, a geographical location of the buyer node, and other information. The interference validation response includes, for example, a change ΔI_{P}^{f} of the accumulated interferences the primary system is subjected to caused by the transaction.

In addition, the calculation unit 101 is further configured to calculate a performance impact based on the transaction type and transaction volume of the transaction, and calculate the transaction feature based on a weighted sum of a utility function of the performance impact and a utility function of the interference impact. For example, the transaction feature may be calculated through the following equation (1):

$$ℱ = a \cdot f ( X , {X}_{0} ) + b \cdot f ( Δ {I}_{P}^{i} , Δ {I}_{th} ) \qquad ( 1 )$$

In equation (1), a and b represent feature weights, which may be set by the CxM based on an actual requirement, and satisfy a+b=1; X and X₀ represent a transaction volume (such as a transaction volume of a bandwidth and/or power) and a reference value of the transaction volume, respectively; ΔI_{P}ⁱ represents an impact of the transaction on the accumulated interferences of the primary system; ΔIₜₕ represents a reference value of the impact of the transaction on the accumulated interferences of the primary system; ƒ(x, x₀) represents a utility function of a parameter x, and x₀ represents a reference value or threshold of the parameter x.

The utility function may be calculated through the following equation (2):

$$f ( x , {x}_{0} ) = \frac{1}{2} \{ tanh [ {log}_{2} ( x / {x}_{0} ) + {η}_{x} ] {σ}_{x} + 1 \} \qquad ( 2 )$$

In equation (2), ηₓ and σₓ represent adjustable parameters. It should be noted that in a case of x≤0, a same parameter needs to be added to x and x₀ in the above equation to ensure that the equation meets the definition.

For example, the calculation unit 101 may be further configured to determine respective weights of the utility function of the performance impact and the utility function of the interference impact (that is, a and b in equation (1)) based on one or more of the following: an application scenario of the buyer node, and an interference status of the primary system. In this way, a trade-off between a resource requirement of the transaction and the protection of the primary system can be done. For example, in a case that the accumulated interferences the primary system is subjected to are high, the weight (b) of the utility function of the interference impact should be increased, so that a transaction capable of reducing the accumulated interferences tends to be processed more preferentially. In a case that the accumulated interferences the primary system is subjected to are low, the weight of the utility function of the performance impact can be increased, so that a transaction capable of improving the network performance tends to be processed more preferentially.

After the transaction feature is calculated by the calculation unit 101, the generation unit 102 generates a transaction endorsement response at least based on the transaction feature. For example, the transaction feature is included in the transaction endorsement response. Subsequently, the communication unit 103 transmits the transaction endorsement response to the buyer node.

In addition, the calculation unit 101 is further configured to determine a dynamic adjustment parameter of the transaction feature based on the transaction endorsement request. The dynamic adjustment parameter is for dynamically adjusting the transaction feature during a queuing procedure of the transaction. The dynamic adjustment parameter is further contained in the transaction endorsement response by the generation unit 102. Subsequently, the communication unit 103 transmits the transaction endorsement response to the buyer node.

Since the wireless environment (such as the location of the buyer node and the interferences to the primary system) is dynamically changing, the transaction for wireless resources is time-sensitive. Therefore, the transaction feature that reflects the priority level of the transaction for wireless resources may change with the wireless environment and a queuing time. In this embodiment, this function is implemented through the above mentioned dynamic adjustment parameter.

For example, the dynamic adjustment parameter may include a transaction feature loss factor and/or a transaction feature compensation factor. The transaction feature loss factor is for considering a transaction feature loss caused by a user equipment mobility and transaction processing delay, and the transaction feature compensation factor is for compensating for a transaction feature loss caused by a transaction queuing time. By using this dynamic adjustment parameter to dynamically update the transaction feature, a certain queuing time is allowed for the transaction to improve satisfaction degree of the buyer node on one hand, and it is avoided to process a transaction that is queued for too long on the other hand.

The transaction feature loss factor may depend on the geographical location of the buyer node, and the transaction feature compensation factor may depend on the historical transaction status of the buyer node.

For example, the transaction feature loss factor may be represented as α as shown in the following equation (3),

$$α = \{ \begin{matrix}{α}_{u} , the buyer CBSD is in a city \\ {α}_{r} , the buyer CBSD is in a suburb\end{matrix} \qquad ( 3 )$$

Here, the transaction feature loss factor α is for simulating a reduction in transaction utility due to existence of the queuing time and user mobility.

The transaction feature compensation factor may be represented as β as shown in the following equation (4), which is for compensating for a transaction feature loss caused by a queuing time.

$$β = ρ \cdot f ( Δ {I}_{P}^{i} , Δ {I}_{th} ) , 0 < ρ \leq 1 \qquad ( 4 )$$

In equation (4), ƒ(ΔI_{P}ⁱ, ΔIₜₕ) represents a utility value of an impact produced by a transaction on accumulated interferences a primary system is subjected to, and ρ may be designed to be related to a historical transaction status of a buyer CBSD. For example, in a case that a historical transaction of a node is always 10 MHz, a transaction of the node should be compensated for when the transaction is still 10 MHz, to prevent the transaction feature of the transaction from being always sorted lower due to a low transaction utility.

In summary, with the electronic apparatus 100 according to this embodiment, the transaction feature for the transaction for wireless resources is generated based on both the interference impact and the performance impact. Hence, in management of transactions for wireless resources, protection of the primary system can be improved while a transaction processing efficiency and a resource utilization efficiency can be improved. In addition, with the electronic apparatus 100 according to this embodiment, a dynamic adjustment of the transaction feature can be realized by setting the dynamic adjustment parameter for the transaction feature, to adapt to dynamic changes in the wireless environment and changes in the queuing time, so that processing of the transaction is further optimized.

### Second Embodiment

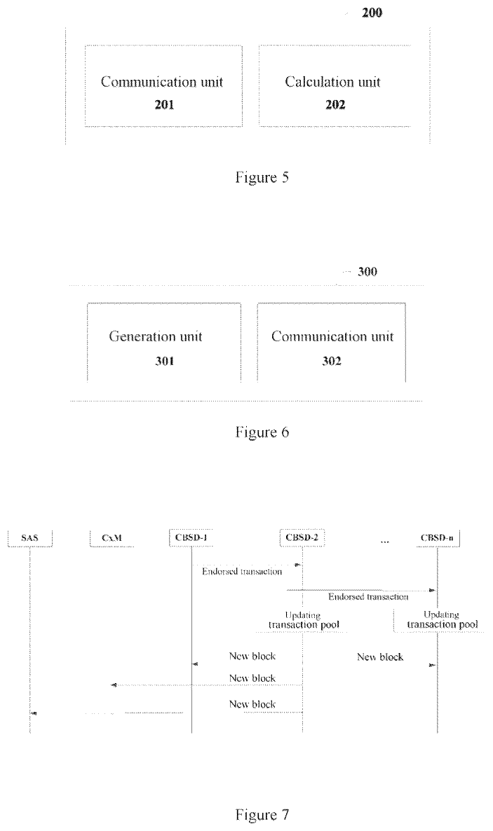

FIG. 5 shows a functional block diagram of an electronic apparatus 200 for wireless communications according to another embodiment of the present disclosure. As shown in FIG. 5, the electronic apparatus 200 includes: a communication unit 201, configured to receive an interference validation request from a coexistence manager, where the interference validation request includes at least part information in a transaction endorsement request of a buyer node of a transaction for wireless resources; a calculation unit 202, configured to calculate, in response to the interference validation request, an interference impact to be produced by the transaction on accumulated interferences a primary system is subjected to, and generate an interference validation response based on the interference impact; where the communication unit 201 is further configured to transmit the interference validation response to the coexistence manager.

The communication unit 201 and the calculation unit 202 may be implemented by one or more processing circuitries. The processing circuitry may be implemented as chips or processors, for example. Moreover, it should be understood that various functional units in the electronic apparatus shown in FIG. 5 are only logical modules divided based on their specific functions, and are not intended to limit a specific implementation.

The electronic apparatus 200 may be provided on a SAS or communicatively connected to the SAS, for example. The SAS includes information of a protection point of the primary system, and is responsible for ensuring a communication quality of the primary system.

Here, it should be noted that the electronic apparatus 200 may be implemented at a chip level or at an apparatus level. For example, the electronic apparatus 200 may serve as the SAS itself and may further include external devices such as a memory and a transceiver (not shown in the Figure). The memory may store related data information and programs that the electronic apparatus needs to execute to achieve various functions. The transceiver may include one or more communication interfaces to support communications with different devices (such as another SAS, CxM, CBSD and the like). An implementation of the transceiver is not specifically limited here.

For example, the interference validation request may include an expected transmission parameter of the buyer node and a transmission parameter of a seller node of the transaction.

For example, the calculation unit 202 may calculate the interference impact, that is, a change in the accumulated interferences the primary system is subjected to, as follows:

$$Δ {I}_{p}^{i} = {I}_{p}^{agg} + {I}_{buy}^{i} - {I}_{sell}^{i} \qquad ( 5 )$$

In equation (5), I_{P}^{agg} represents the accumulated interferences the primary system is currently subjected to, I_{buy}ⁱ represents interferences caused by a buyer CBSD to the primary system, and Iₛₑₗₗⁱ represents interferences caused by a seller CBSD to the primary system.

The interferences caused by a CBSD-j to the primary system may be calculated through the following equation (6):

$${I}_{J} = {P}_{t}^{j} - P l + {G}_{i} + {G}_{r} \qquad ( 6 )$$

In equation (6), Pₜ^{j} represents a transmission power of CBSD-j; Pl represents a path loss of radio wave propagation, which may be calculated based on a path loss model; Gₜ and Gᵣ represent antenna gains of a transmitter and a receiver, respectively. Furthermore, the accumulated interferences of the primary system may be expressed as:

$${I}_{p}^{agg} = {\sum }_{j = 1}^{N} {I}_{J} \qquad ( 7 )$$

In equation (7), N represents the number of CBSDs in a scenario.

The interference validation response transmitted by the communication unit 201 may include, for example, the interference impact ΔI_{P}ⁱ calculated by the calculation unit 202.

In summary, with the electronic apparatus 200 according to the present embodiment, the impact, caused by the transaction for wireless resources, on the accumulated interferences the primary system is subjected to is calculated. Thereby, the impact is considered when sorting the transactions, so that a protection of the primary system is realized effectively.

### Third Embodiment

FIG. 6 shows a functional block diagram of an electronic apparatus 300 according to another embodiment of the present disclosure. As shown in FIG. 6, the electronic apparatus 300 includes: a generation unit 301, configured to generate a transaction endorsement request for a transaction of wireless resources; a communication unit 302, configured to transmit the transaction endorsement request to a spectrum management device; and receive, from the spectrum management device, a transaction endorsement response to the transaction endorsement request; where the transaction endorsement response includes a transaction feature of the transaction, and the transaction feature is calculated by the spectrum management device based on an interference impact on accumulated interferences a primary system is subjected to and a performance impact on network performance to be produced by the transaction.

The generation unit 301 and the communication unit 302 may be implemented by one or more processing circuitries, which may be implemented as a chip or a processor, for example. Moreover, it should be understood that various functional units in the electronic apparatus shown in FIG. 6 are only logical modules divided based on their specific functions, and are not intended to limit a specific implementation.

The electronic apparatus 300 may be provided on a CBSD or communicatively connected to the CBSD, for example. The CBSD may be a network side apparatus, such as any type of TRP (transmit and receive point) and a base station apparatus, such as an eNB or gNB.

Here, it should be noted that the electronic apparatus 300 may be implemented at a chip level or at an apparatus level. For example, the electronic apparatus 300 may serve as the CBSD itself and may further include external devices such as a memory and transceiver (not shown in the Figure). The memory may store related data information and programs that the electronic apparatus needs to execute to achieve various functions. The transceiver may include one or more communication interfaces to support communications with different devices (such as another CBSD, SAS, CxM and the like). An implementation of the transceiver is not specifically limited here.

Reference is still made to the flowchart shown in FIG. 4. Initially, the communication unit 302 is further configured to transmit a registration request to the spectrum management device (such as a CxM) and receive a registration response from the spectrum management device. The registration request includes an indication that the transaction node supports a wireless resource transaction function and/or a transaction node supports a wireless resource transaction processing function. In a case that the registration request includes the indication that the transaction node supports a wireless resource transaction function, it means that the transaction node (CBSD) supports a blockchain transaction function. In a case that the registration request includes the indication that the transaction node supports a wireless resource transaction processing function, it means that the transaction node (CBSD) supports a blockchain transaction processing function. The CBSD with the blockchain transaction function can perform a spectrum transaction, and the CBSD with the blockchain transaction processing function can package and process a transaction.

In addition, before the transaction endorsement request is generated, the communication unit 302 is further configured to transmit a transaction request to the spectrum management device and receive a transaction response from the spectrum management device. The transaction request includes a transaction type and/or a service type. The transaction type includes information indicating a type of wireless resources for transaction, for example, includes one or more of a bandwidth and power. The service type may indicate a service scenario (eMBB, mMTC, URLLC, etc.). The spectrum management device (such as CxM) queries for wireless resources and a seller node available for the transaction in response to the transaction request, and includes information of the wireless resources and the seller node available for the transaction in the transaction response. For detailed description, reference may be made to the operations performed by the CxM in the first embodiment, which is not repeated here.

Subsequently, the generation unit 301 is further configured to perform a wireless environment measurement related to the transaction type based on the transaction response, for example, measuring interferences, an available frequency band, and the number of users. The generation unit 301 may generate a transaction endorsement request for the transaction at least based on a measurement result, and transmit the measurement result to the CxM, so that the CxM endorses the transaction. As mentioned above, besides validating basic information of the buyer node (buyer CBSD), an endorsement process further includes calculating a transaction feature.

The transaction endorsement request includes, for example, one or more of the following: basic information of the buyer node, a measurement report of a wireless environment measurement performed by the buyer node for the transaction, an expected transmission parameter of the buyer node, a transmission parameter of the seller node, a geographical location of the buyer node, a geographical location of the seller node, a transaction frequency band, a transaction type, a transaction volume and a service type. Information in the transaction endorsement request is used by the spectrum management device to determine the transaction feature of the transaction. Subsequently, the communication unit 302 receives, from the CxM, a transaction endorsement response including the transaction feature.

FIG. 7 shows an example of an information flow among different CBSDs. As shown in the figure, the communication unit 302 of the buyer node (shown as CBSD-1 in FIG. 7) broadcasts the endorsed transaction to processing nodes in the network that supports the wireless resource transaction processing function (shown as CBSD-2 to CBSD-n in FIG. 7). The endorsed transaction includes a transaction feature in addition to information of the transaction itself. Each processing node maintains a transaction pool and processes a transaction in the transaction pool based on the blockchain technology.

In other words, the CBSDs in the network (such as CBSD-1 to CBSD-n) form a blockchain. Each of the CBSDs maintains its own transaction pool and maintains synchronization of a transaction processing among the CBSDs through the blockchain. A detailed description of maintenance of the transaction pool is given below.

After receiving a new endorsed transaction, the processing node would update the maintained transaction pool. At a new block generation timing, a processing node that obtains block generation authorization packages the transaction to be processed to generate a new block, and broadcasts the new block to all CBSD nodes, the CxM and the SAS on the blockchain.

Correspondingly, the communication unit 302 is further configured to receive a block from the processing node authorized for block generation, and obtain a processing result of the transaction for this node by parsing the block.

It should be noted that the buyer node CBSD-1 in the above example may or may not support the wireless resource transaction processing function.

In addition, the transaction endorsement response received by the communication unit 302 from the spectrum management device may further include a dynamic adjustment parameter of the transaction feature. The dynamic adjustment parameter is further included in the endorsed transaction. The dynamic adjustment parameter is for dynamically adjusting the transaction feature during a queuing process of the transaction.

Since the wireless environment (such as a location of the buyer node and interferences to the primary system) changes dynamically, the transaction of wireless resources is time-sensitive. Therefore, the transaction feature that reflects a priority level of the transaction of wireless resources changes with the wireless environment and the queuing time. The dynamic adjustment parameter may be used to reflect an impact produced by the change.

As an example, the dynamic adjustment parameter may include a transaction feature loss factor and/or a transaction feature compensation factor. The transaction feature loss factor is for considering a transaction feature loss caused by a user equipment mobility and transaction processing delay, and the transaction feature compensation factor is for compensating for a transaction feature loss caused by a transaction queuing time.

The dynamic adjustment parameter together with the transaction feature are provided to the processing node, so that the transaction feature of the corresponding transaction is dynamically updated during the queuing process at the processing node. On one hand, a certain queuing time is allowed for the transaction to improve satisfaction degree of the buyer node; and on the other hand, it is avoided to process a transaction that is queued for too long.

For example, the transaction feature loss factor may depend on the geographical location of the buyer node, and the transaction feature compensation factor may depend on the historical transaction status of the buyer node. Specific examples may be referred to equation (3) and equation (4), which are not repeated here.

In summary, with the electronic apparatus 300 according to this embodiment, the transaction of wireless resources is performed based on the transaction feature that considers both the interference impact and the performance impact. Hence, in management of transactions for wireless resources, protection of the primary system can be improved while a transaction processing efficiency and resource utilization efficiency can be improved. In addition, the management of transactions based on the blockchain technology enables a decentralized management of wireless resources.

### Fourth Embodiment

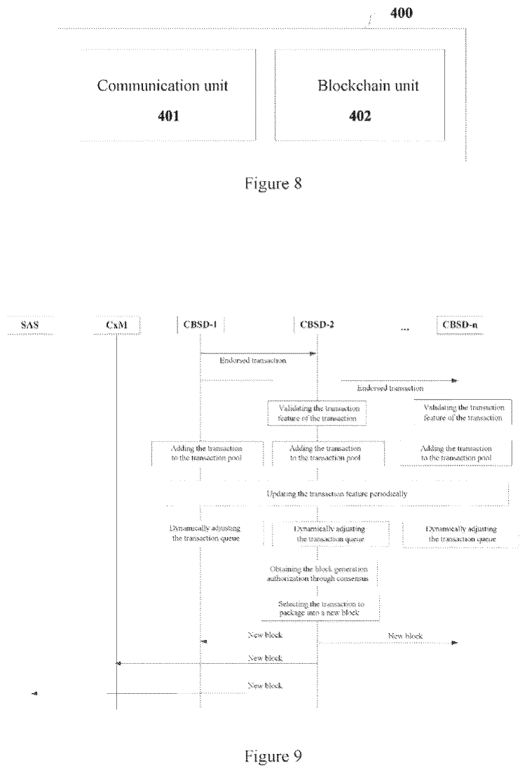

FIG. 8 shows a functional block diagram of an electronic apparatus 400 for wireless communications according to another embodiment of the present disclosure. As shown in FIG. 8, the electronic apparatus 400 includes: a communication unit 401, configured to receive an endorsed transaction for wireless resources which includes a transaction feature calculated by a spectrum management device based on an interference impact on accumulated interferences a primary system is subjected to and a performance impact on network performance to be produced by the transaction; and a blockchain unit 402 configured to add the received transaction as a new transaction into a transaction pool maintained based on a blockchain technology.

The communication unit 401 and the blockchain unit 402 may be implemented by one or more processing circuitries. The processing circuitry may be implemented as a chip or a processor, for example. Moreover, it should be understood that various functional units in the electronic apparatus shown in FIG. 8 are only logical modules divided based on their specific functions, and are not intended to limit a specific implementation.

The electronic apparatus 400 may be provided on a CBSD or communicatively connected to the CBSD, for example. The CBSD may be a network side apparatus, such as any type of TRP (transmit and receive point) and a base station apparatus, such as an eNB or gNB.

Here, it should be noted that the electronic apparatus 400 may be implemented at a chip level or at a device level. For example, the electronic apparatus 400 may serve as the CBSD itself and may further include external devices such as a memory and transceiver (not shown in the drawing). The memory may store related data information and programs that the electronic apparatus needs to execute to achieve various functions. The transceiver may include one or more communication interfaces to support communications with different devices (such as another CBSD, SAS, CxM, and the like). An implementation of the transceiver is not specifically limited here.

It should be noted that the CBSD where the electronic apparatus 400 is located supports a wireless resource transaction processing function and is registered with the spectrum management device when initialized. For details, reference may be made to relevant content in the third embodiment. The spectrum management device may include the CxM and the SAS.

Here, the received endorsed transaction may be a transaction in which the CBSD where the electronic apparatus 400 is located serves as a buyer node (in this case, the endorsed transaction is received from the CxM), or may be an endorsed transaction transmitted by another CBSD in the same blockchain. Each CBSD serving as a processing node maintains a transaction pool based on blockchain technology. The transaction pool records information of to-be-processed transactions in the network. In this case, it is necessary for the blockchain unit 402 to add the received new transaction to the transaction pool.

For ease of understanding, FIG. 9 shows a schematic diagram of a relevant information flow of a transaction management based on blockchain. It is assumed that CBSD-1 requires for a transaction and receives an endorsed transaction from the CxM, CBSD-1 to CBSD-n are all transaction processing nodes, and CBSD-2 to CBSD-n receive an endorsed transaction broadcast from CBSD-1. The electronic apparatus 400 according to the present embodiment may be arranged on each of CBSD-1 to CBSD-n. Each of the CBSD-1 to CBSD-n adds the new transaction to the transaction pool maintained by itself.

As mentioned before, service types of transactions may be different for the rich application scenarios of the fifth-generation mobile communications and even the sixth-generation mobile communications, such as eMBB, URLLC, and mMTC. Therefore, a solution of multiple transaction queues is provided in this embodiment. That is, on each CBSD, the blockchain unit 402 maintains an individual transaction queue for each of multiple application scenarios (or each of service types). In addition, the blockchain unit 402 may maintain an individual transaction queue for each transaction type. In this case, when adding a new transaction to the transaction pool, the blockchain unit 402 determines a transaction queue to which the new transaction is to be added based on a scenario (or service type) or transaction type for the new transaction. The scenarios here include, for example, eMBB, URLLC, mMTC, and the like.

In this way, blockchain transactions can be conducted for different communication services, so that the blockchain technology is more suitable for the field of wireless communications.

In view of this, in this embodiment, in addition to verifying basic information of the transaction, such as a digital signature and a buyer address, an operation of adding a new transaction to the transaction pool further includes verifying the transaction feature of the transaction to determine the type of the transaction and select a transaction queue corresponding to the type.

In a case that a capacity of the selected transaction queue is not limited or in a case that a current transaction queue, although having a limited capacity, has a sufficient remaining capacity, the blockchain unit 402 adds a new transaction having complete basic information to the transaction queue. Alternatively, in a case that an interference utility value related to the interference impact in the transaction feature of a new transaction is greater than a predetermined value (as shown in the following equation (8)), the blockchain unit 402 adds the new transaction to the transaction queue.

$$f ( Δ {I}_{p}^{i} , Δ {I}_{th} ) > {f}_{I}^{min} \qquad ( 8 )$$

In equation (8), ƒ(ΔI_{P}ⁱ, ΔIₜₕ) represents an interference utility value related to the interference impact in the transaction feature of a new transaction, and ƒ_{I}^{min} represents a predetermined value set for the interference utility.

On the contrary, in a case that the capacity of the selected transaction queue is insufficient (for example, the transaction queue is full), the blockchain unit 402 determines whether to add the new transaction based on the transaction feature of the new transaction. In other words, the new transaction is added to a transaction queue only in a case that the transaction feature of the new transaction meets a predetermined condition. Otherwise, the new transaction is not added to the transaction queue.

For example, the blockchain unit 402 is configured to substitute the new transaction for a transaction with the lowest transaction feature in the transaction queue to which the new transaction is to be added in a case that the following condition is satisfied: the interference utility value related to the interference impact in the transaction feature of the new transaction being greater than 0; and the transaction feature of the new transaction being higher than the transaction feature of the transaction with the lowest transaction feature.

This condition may be expressed as follows:

$${ℱ}_{new} = ( 1 + k ) {ℱ}_{min}^{i} , 0 \leq k \leq 1 and f ( Δ {I}_{p}^{i} , Δ {I}_{th} ) > 0 \qquad ( 9 )$$

In equation (9), [symbol] represents the transaction feature of the new transaction; [symbol] represents a minimum transaction feature value in the i-th transaction queue (the queue to which the transaction is added); and k represents an adjustable coefficient, for specifying a minimum transaction feature that the new transaction should satisfy.

It should be noted that the above condition is not restrictive, but may be modified variously based on an actual requirements. For example, the equation (9) may be modified to

$${ℱ}_{new} = ( 1 + k ) {ℱ}_{min}^{i} , 0 \leq k \leq 1 and f ( Δ {I}_{p}^{i} , Δ {I}_{th} ) > {f}_{I}^{min} ,$$

or the like

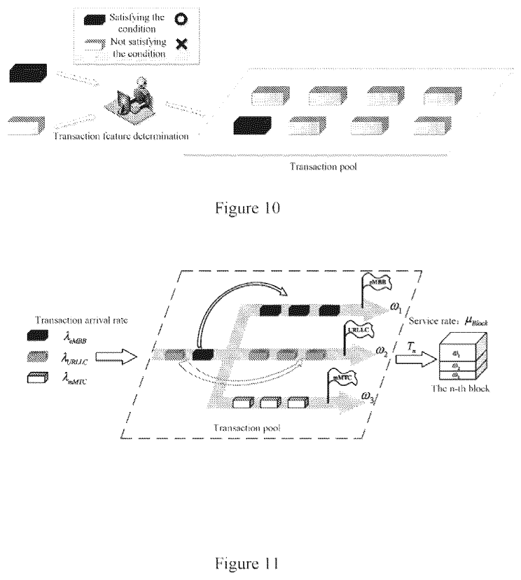

In summary, FIG. 10 shows a general schematic diagram of a transaction pooling process. That is, in this embodiment, when adding a new transaction to the transaction pool, it is necessary to determine whether the transaction feature satisfies the predetermined condition.

For example, transactions in a transaction queue may be ranked in a descending order based on transaction features. For example, a transaction with the highest transaction feature is ranked first in the queue, and so on. In this way, it facilitates to processing a transaction with a high transaction feature preferentially.

As shown in FIG. 9, at a new time instant for block generation, assuming that the blockchain unit 402 of CBSD-2 obtains a block generation authorization through consensus, the blockchain unit 402 may select and package transactions with high transaction features from among transaction queues to form a new block.

Since the number of transactions in a new block is limited, the number of selectable transactions allocated to a transaction queue is limited. For example, the number of transactions allowed in the new block may be evenly allocated among the transaction queues, that is, the blockchain unit 402 selects the same number of transactions from the respective transaction queues.

Preferably, the blockchain unit 402 may determine the number of transactions to be selected from each transaction queue based on a weight of the transaction queue. The blockchain unit 402 may allocate the number of selectable transactions in each transaction queue according to importance or urgency of the transactions, that is, set a weight for each transaction queue. For example, the blockchain unit 402 may determine the weight of a transaction queue based on one or more of the following: a sum of transaction features of transactions in each transaction queue, or an importance factor of each transaction queue. The importance factor of a transaction queue may be determined based on the number of important transactions in the transaction queue, where an important transaction is a transaction whose initial value of the transaction feature is above a predetermined threshold ( [symbol] ≥ [symbol] ). Such transaction is in a large enough demand, that is, causes a large enough improvement on a network performance (such as a network cumulative throughput), while can reduce interferences to a primary user.

For example, the weight of a transaction queue may be calculated as follows:

$${ω}_{i} = \frac{{φ}_{i} {\sum }_{q = 1}^{{Q}_{i}} {ℱ}_{q}^{i}}{{\sum }_{i = 1}^{{N}_{q}} {φ}_{i} ( {\sum }_{q = 1}^{{Q}_{i}} {ℱ}_{q}^{i} )} \qquad ( 10 )$$

In equation (10), Qᵢ represents the number of transactions in the i-th transaction queue; [symbol] represents the transaction feature of the q-th transaction in the i-th transaction queue; N_{q} represents the number of transaction queues; and φᵢ represents an importance factor of the i-th transaction queue. In a case that there is no difference in importance of transaction queues, there is ∀i∈[1, N_{q}], φᵢ=1.

After the weights of the transaction queues are determined, the blockchain unit 402 may calculate the number of transactions that can be packaged in each transaction queue based on the weights and a block capacity, and select and package top-ranked transactions in each transaction queue based on the number of transactions that can be packaged in the transaction queue, to generate a new block. In this way, transactions with high transaction features in the transaction queues can be processed preferentially. That is, important transactions can be processed preferentially, so that a queuing time of important transactions is effectively reduced, and an expected utility of the important transactions is prevented from being reduced due to a long queuing time.

FIG. 11 schematically shows a schematic diagram of selecting a transaction from among transaction queues and generating a new block. In a transaction pool, an individual transaction queue is maintained for each of eMBB, URLLC and mMTC respectively. For example, the blockchain unit 402 calculates, based on weights of the transaction queues, that co transactions can be selected from a transaction queue for the eMBB, ω₂ transactions can be selected from a transaction queue for the URLLC, and ω₃ transactions can be selected from a transaction queue for the mMTC; and packages to form an n-th block at the block generation timing Tn. FIG. 11 further shows a transaction arrival rate and block service rate of each service.

Subsequently, as shown in FIG. 9, the communication unit 401 broadcasts the new block to all processing nodes and a spectrum management device on the blockchain. After receiving the new block, a processing node verifies the new block and deletes a transaction identical to that in the new block from the transaction pool maintained by the processing node.

Assuming that a transaction of the CBSD-1 has a transaction feature satisfying the requirement and thus is selected and packaged into a new block by a blockchain processing unit 402 of CBSD-2, the transaction is broadcasted to all CBSDs, CxM and SAS on the blockchain for synchronization and verification. After the verification is passed, the transaction of CBSD-1 is executed, so that CBSD-1 obtains wireless resources involved in the transaction.

Preferably, as shown in the dashed line block in FIG. 9, when transactions are queued in the transaction pool, the blockchain unit 402 may further periodically update the transaction features of the transactions in the transaction queues, and dynamically adjust the transaction queues based on the updated transaction features, such as reordering the transactions. Update of a transaction feature may be expressed as the following equation (11):

$${ℱ}_{j}^{n} = g ( {t}_{j} ) \cdot {ℱ}_{j}^{ini} , {t}_{j} > 0 \qquad ( 11 )$$

In equation (11), [symbol] and [symbol] represents a transaction feature of transaction j at the n-th feature update time instant and an initial transaction feature of transaction j when entering the transaction pool, respectively; and g(tⱼ) represents a transaction feature update function, where the independent variable tⱼ represents a queuing time of the transaction j.

In an example, the received endorsed transaction further includes a dynamic adjustment parameter of the transaction, and the blockchain unit 402 is configured to update the transaction feature of the transaction based on the dynamic adjustment parameter, the queuing time, and the block generation time.

The dynamic adjustment parameter includes, for example, a transaction feature loss factor and/or a transaction feature compensation factor. The transaction feature loss factor is for considering a transaction feature loss caused by a user equipment mobility and transaction processing delay. The transaction feature compensation factor is for compensating for a transaction feature loss caused by a transaction queuing time. By using this dynamic adjustment parameter to dynamically update the transaction feature, a certain queuing time is allowed for the transaction to improve satisfaction degree of the buyer node on the one hand, and it is avoided to process a transaction that is queued for too long on the other hand. The transaction feature loss factor may depend on a geographical location of a buyer node, and the transaction feature compensation factor may depend on a historical transaction status of the buyer node.

The following equation (12) shows an example of the transaction feature update function g(tⱼ):

$$g ( {t}_{j} ) = [ 1 + γ \cdot {( \frac{β}{α} )}^{δ} ] exp \{ - θ \cdot {[ - ( \frac{β}{α} \cdot m \cdot {τ}_{block} ) ]}^{2} \} , m > 0 \qquad ( 12 )$$

In equation (12), γ and δ are used to determine the maximum value of the function; σ_{block} represents an average interval of block generation; m is used to define the number of intervals of block generation;

$$( \frac{β}{α} \cdot m \cdot {τ}_{block} )$$

determines a time instant when the function reaches the maximum value, which is also an inflection point of the function. α and β represent the transaction feature loss factor and the transaction feature compensation factor, respectively, examples of which are shown in equations (3) and (4) in the first embodiment.

θ determines a slope of g(tⱼ). In order to satisfy g(0)=1, that is, the transaction feature has an initial value when the queuing time tⱼ=0, θ should satisfy:

$$θ = \frac{ln [ 1 + γ \cdot {( \frac{β}{α} )}^{δ} ]}{{( \frac{β}{α} )}^{2} \cdot {m}^{2} \cdot {τ}_{block}^{2}} \qquad ( 13 )$$

The blockchain unit 402 reorders the transactions in the transaction queue based on magnitudes of the updated transaction feature. For example, a transaction whose transaction feature falls below a predetermined threshold may be removed. In this way, a transaction with a low probability of transaction success can be prevented from occupying the space of the transaction pool, so that accumulation of transactions in the transaction pool is effectively prevented, and a storage space of the transaction pool is optimized.

In addition, the blockchain unit 402 may be further configured to calculate a transaction satisfaction degree based on an execution status of transactions in the transaction pool. The transaction satisfaction degree is used to evaluate the execution status of transactions of wireless resources at each node.

For example, the transaction satisfaction degree may be calculated using the following equation (14):

$${S}_{i} = {\sum }_{j = 1}^{{N}_{i}} {S}_{j}^{i} \qquad ( 14 )$$

In equation (14), Nᵢ represents a total number of transactions of wireless resources created by CBSD-i within a period of time; Sⱼⁱ represents a satisfaction degree brought by the j-th transaction created by CBSD-i. When a transaction is completed, a satisfaction degree thereof is calculated by the following equation:

$${S}_{j}^{i} = {α}^{′} \cdot f ( {X}_{j} , {X}_{th} ) + {b}^{′} \cdot f ( {t}_{j} , {t}_{th} ) \qquad ( 15 )$$

In equation (15), a′ and b′ represents adjustable weights, and satisfy a′+b′=1; ƒ(tⱼ, tₜₕ) represents a utility function of a queuing time tⱼ; ƒ(Xⱼ, Xₜₕ) represents a utility function of a transaction volume Xⱼ; tₜₕ represents a threshold (reference value) of the queuing time; and Xₜₕ represents a threshold (reference value) of the transaction volume. The above equation means that the shorter the queuing time is and the greater the volume of obtained resources is, the higher the satisfaction degree is. On the contrary, if a transaction is discarded, the satisfaction degree is calculated through the following equation (16):

$${S}_{j}^{i} = {c}^{′} \cdot f ( {X}_{j} , {X}_{th} ) \qquad ( 16 )$$

In equation (16), c′ represents an adjustable weight and satisfies −1≤c′<0.

In summary, with the electronic apparatus 400 according to this embodiment, the transaction of wireless resources is performed based on the transaction feature that considers both the interference impact and the performance impact and using the blockchain technology, so that the management of transactions of wireless resources can be achieved in a distributed manner, the protection of the primary system can be improved while the transaction processing efficiency and resource utilization efficiency can be improved. In addition, the electronic apparatus 400 according to this embodiment dynamically updates the transaction feature based on the dynamic adjustment parameter to adapt to dynamic changes in the wireless environment and changes in the queuing time, so that the management of transactions is further optimized.

### Fifth Embodiment

In the above description of embodiments of the electronic apparatuses for wireless communications, it is apparent that some processing and methods are further disclosed. In the following, a summary of the methods are described without repeating details that are described above. However, it should be noted that although the methods are disclosed when describing the electronic apparatuses for wireless communications, the methods are unnecessary to adopt those components or to be performed by those components described above. For example, implementations of the electronic apparatuses for wireless communications may be partially or completely implemented by hardware and/or firmware. Methods for wireless communications to be discussed blow may be completely implemented by computer executable programs, although these methods may be implemented by the hardware and/or firmware for implementing the electronic apparatuses for wireless communications.

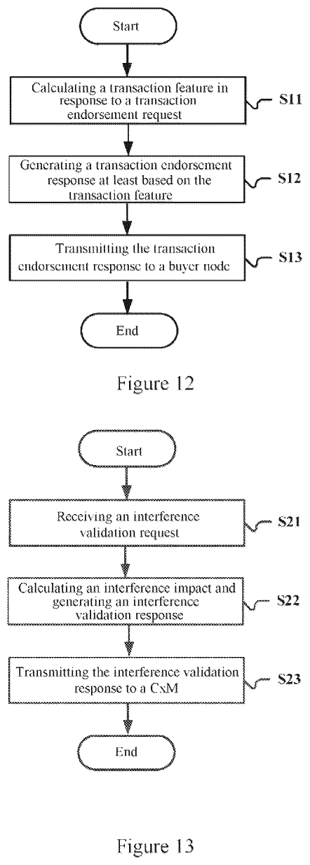

FIG. 12 shows a flowchart of a method for wireless communications according to an embodiment of the present disclosure. The method includes: calculating, in response to a transaction endorsement request from a buyer node of a transaction for wireless resources, a transaction feature of the transaction based on an interference impact on accumulated interferences a primary system is subjected to and a performance impact on network performance to be produced by the transaction (S11); generating, at least based on the transaction feature, a transaction endorsement response (S12); and transmitting the transaction endorsement response to the buyer node (S13). The method may be implemented, for example, on a CxM side. The buyer node is a CBSD, for example.

The transaction endorsement request may include, for example, one or more of the following: basic information of the buyer node, a measurement report of a wireless environment measurement performed by the buyer node for the transaction, an expected transmission parameter of the buyer node, a transmission parameter of a seller node, a geographical location of the buyer node, a geographical location of the seller node, a transaction frequency band, a transaction type, a transaction volume and a service type. The transaction type includes, for example, information indicating the type of wireless resources for the transaction. The transaction type may include one or more of the following: bandwidth, and power.

Although not shown in the FIG. 12, the method above may further include the following step: transmitting an interference validation request to a spectrum access system SAS, so that the SAS calculates the interference impact based on the interference validation request; and receiving an interference validation response from the SAS, where the interference validation request includes at least part information in the transaction endorsement request, and the interference validation response includes information of the calculated interference impact.

For example, in S11, the performance impact may be calculated based on the transaction type and transaction volume of the transaction, and the transaction feature may be calculated based on a weighted sum of a utility function of the performance impact and a utility function of the interference impact. Respective weights of the utility function of the performance impact and the utility function of the interference impact may be determined based on one or more of the following: an application scenario of the buyer node, or an interference status of the primary system. The transaction feature represents a priority level of processing the transaction or importance of the transaction.

The above method may further include: determining a dynamic adjustment parameter of the transaction feature based on the transaction endorsement request and containing the dynamic adjustment parameter in the transaction endorsement response, where the dynamic adjustment parameter is used for dynamically adjusting the transaction feature during a queuing procedure of the transaction. For example, the dynamic adjustment parameter includes a transaction feature loss factor and/or a transaction feature compensation factor. The transaction feature loss factor is for considering a transaction feature loss caused by user equipment mobility and transaction processing delay, and the transaction feature compensation factor is for compensating for a transaction feature loss caused by a transaction queuing time. For example, the transaction feature loss factor depends on the geographical location of the buyer node, and the transaction feature compensation factor depends on the historical transaction status of the buyer node.

Although not shown in the figure, the above method may further include: receiving a transaction request from the buyer node before receiving the transaction endorsement request from the buyer node; querying for wireless resources and seller nodes available for transaction in response to the transaction request; and transmitting information of the wireless resources and seller node available for transaction to the buyer node as a transaction response, where the transaction request includes the transaction type.

The above method may further include: receiving a registration request from a transaction node and transmitting a registration response to the transaction node, where the registration request includes an indication that the transaction node supports a wireless resource transaction function and/or that the transaction node supports a wireless resource transaction processing function.

The above method corresponds to the electronic apparatus 100 in the first embodiment. For specific details, reference may be made to the first embodiment, which is not repeated here.

FIG. 13 shows a flowchart of a method for wireless communications according to another embodiment of the present disclosure. The method includes: receiving an interference validation request from a CxM, where the interference validation request includes at least part information in a transaction endorsement request of a buyer node of a transaction for wireless resources (S21); calculating, in response to the interference validation request, an interference impact to be produced by the transaction on accumulated interferences a primary system is subjected to, and generating an interference validation response based on the interference impact (S22); and transmitting the interference validation response to the CxM (S23). This method may be executed on an SAS side, for example. The buyer node may be a CBSD.

For example, the interference validation request may include an expected transmission parameter of the buyer node and a transmission parameter of a seller node of the transaction.

The above method corresponds to the electronic apparatus 200 in the second embodiment. For specific details, reference may be made to the second embodiment, which is not repeated here.

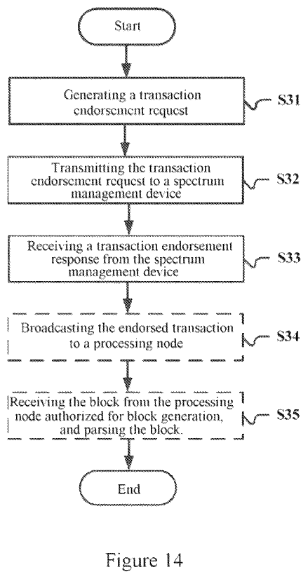

FIG. 14 shows a flowchart of a method for wireless communications according to another embodiment of the present disclosure. The method includes: generating a transaction endorsement request for a transaction of wireless resources (S31); transmitting the transaction endorsement request to a spectrum management device (S32); and receiving, from the spectrum management device, a transaction endorsement response to the transaction endorsement request (S33). The transaction endorsement response includes a transaction feature of the transaction, and the transaction feature is calculated by the spectrum management device based on an interference impact on accumulated interferences a primary system is subjected to and a performance impact on network performance to be produced by the transaction. The method may be performed, for example, on a base station side or CBSD side. The spectrum management device may be a CxM.

For example, the transaction endorsement request may include one or more of the following: basic information of a buyer node, a measurement report of a wireless environment measurement performed by the buyer node for the transaction, an expected transmission parameter of the buyer node, a transmission parameter of a seller node, a geographical location of the buyer node, a geographical location of the seller node, a transaction frequency band, a transaction type, a transaction volume and a service type. The buyer node may be a CBSD. The transaction type includes information indicating the type of wireless resources used for the transaction. The transaction type includes one or more of the following: bandwidth, and power.

Although not shown in the Figure, the above method may further include the following step: transmitting a transaction request to the spectrum management device before generating the transaction endorsement request, and receiving a transaction response from the spectrum management device. The transaction request includes a transaction type. The spectrum management device queries for wireless resources and seller node available for transaction in response to the transaction request, and contains information of the wireless resources and seller node available for transaction in the transaction response. A wireless environment measurement related to the transaction type may be further performed based on the transaction response.

The above method may further include: transmitting a registration request to the spectrum management device and receiving a registration response from the spectrum management device, where the registration request includes an indication that a transaction node supports a wireless resource transaction function and/or that the transaction node supports a wireless resource transaction processing function.

As shown in a dashed line block in the figure, the above method may further include step S34: broadcasting an endorsed transaction to a processing node in a network that supports the wireless resource transaction processing function, where the endorsed transaction includes the transaction feature. The processing node maintains a transaction pool and processes transactions in the transaction pool based on a blockchain technology.

In addition, the transaction endorsement response may further include a dynamic adjustment parameter of the transaction feature, and the endorsed transaction further includes the dynamic adjustment parameter. The dynamic adjustment parameter is for dynamically adjusting the transaction feature during a queuing process of the transaction. For example, the dynamic adjustment parameter includes a transaction feature loss factor and/or a transaction feature compensation factor. The transaction feature loss factor is for considering a transaction feature loss caused by a user equipment mobility and transaction processing delay. The transaction feature compensation factor is for compensating for a transaction feature loss caused by a transaction queuing time.

As shown in another dotted line block in the figure, the above method may further include a step S35: receiving a block from the processing node obtaining block generation authorization, and obtaining the processing result of the transaction for the present node by parsing the block.

The above method corresponds to the electronic apparatus 300 in the third embodiment. For specific details, reference may be made to the third embodiment, which is not repeated here.

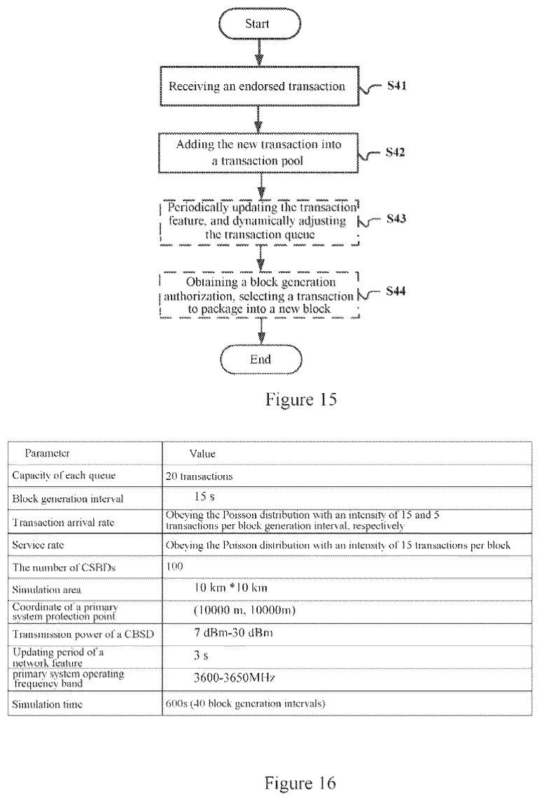

FIG. 15 shows a flowchart of a method for wireless communications according to another embodiment of the present disclosure. The method includes: receiving an endorsed transaction for wireless resources (S41) which includes a transaction feature of the transaction, the transaction feature being calculated by a spectrum management device based on an interference impact on accumulated interferences a primary system is subjected to and a performance impact on network performance to be produced by the transaction; and adding the received transaction as a new transaction into a transaction pool maintained based on a blockchain technology (S42). The method may be performed, for example, on a base station side or CBSD side. The spectrum management device may be a CxM and SAS.

An individual transaction queue may be maintained for each of multiple application scenarios, and the transaction queue to which the new transaction is to be added is determined in step S42 based on the scenario which the new transaction is with respect to. The application scenarios include, for example, eMBB, mMTC, and URLLC.

In step S42, it may be determined whether to add the new transaction based on the transaction feature of the new transaction in a case that a capacity of the transaction queue is insufficient. For example, the new transaction is substituted for a transaction with the lowest transaction feature in the transaction queue to which the new transaction is to be added in a case that the following condition is satisfied: an interference utility value related to the interference impact in the transaction feature of the new transaction being greater than 0; and the transaction feature of the new transaction being higher than that of the transaction with the lowest transaction feature.

As shown in a dashed line block in the figure, the method above may also include step S43: periodically updating the transaction feature of each transaction in each transaction queue, and dynamically adjusting the transaction queue based on the updated transaction feature. For example, the endorsed transaction further includes a dynamic adjustment parameter of the transaction, and the transaction feature of the transaction may be updated based on the dynamic adjustment parameter, a queuing time, and a block generation time. Transactions in the transaction queue may be reordered based on magnitudes of the updated transaction feature and the transaction whose transaction feature falls below a predetermined threshold may be removed.

As shown in another dashed line block in the figure, the above method may further include step S44: obtaining the block generation authorization through consensus at a new block generation timing, selecting and packaging transactions with high transaction features from among transaction queues to form a new block. For example, the number of transactions to be selected from each transaction queue may be determined based on a weight of the transaction queue. A weight of each transaction queue may be determined based on one or more of the following: a sum of the transaction features of the transactions in the transaction queue; or an importance factor of the transaction queue. The importance factor of the transaction queue may be determined based on the number of important transactions in the transaction queue. An important transaction is a transaction whose initial value of the transaction feature is above a predetermined threshold.

In addition, although not shown in the figure, the method may further include: calculating a transaction satisfaction degree based on execution status of transactions in the transaction pool.

The above method corresponds to the electronic apparatus 400 in the fourth embodiment. For specific details, reference may be made to the fourth embodiment, which is not repeated here.

It should be noted that the methods may be performed in combination or separately.

In order to facilitate better understanding of the embodiments of the present disclosure, a simulation example is given below. It should be understood that the parameter configuration, system configuration and the result of this simulation example are illustrative rather than restrictive.

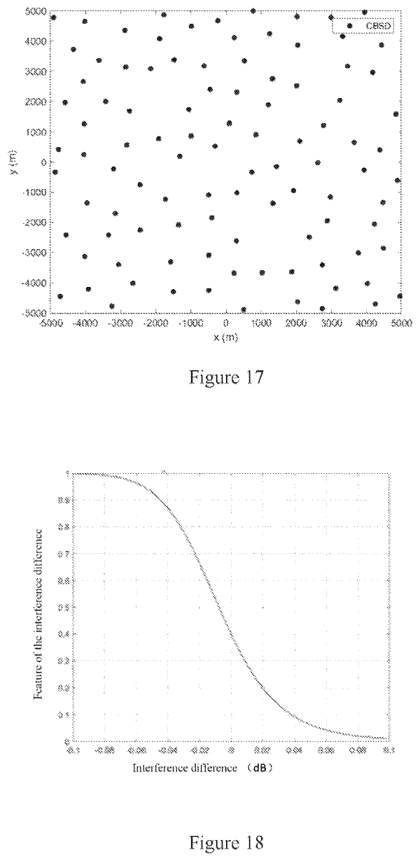

The system scenario in FIG. 1 is still taken as an example, and the simulation parameter configuration is as shown in FIG. 16. A total of 100 CBSDs are randomly distributed in a 10 km×10 km area in the scenario. FIG. 17 shows a schematic diagram of randomly distributed CBSDs. A transmission power of each CBSD is in a range from 7 dBm to 30 dBm. A center coordinate of the simulation area is (0 m, 0 m), and a coordinate of a primary system protection point is (10000 m, 10000 m). A simulation frequency band is 3550 MHz to 3700 MHz, and an operating frequency band of a primary system is 3600 MHz to 3650 MHz. Transactions of wireless resources in the scenario include two types of transactions, i.e., transactions of spectrum resources (bandwidth) and transactions of power resources. Their transaction arrival rates follow the Poisson distribution with an intensity of 15 and 5 transactions per block generation interval, respectively. Individual transaction queues are maintained in the transaction pool for the two transaction types respectively, and a capacity of the transaction queues each is 20 transactions. The block generation interval is set to a fixed 15 seconds, and a capacity of each block follows a Poisson distribution with an intensity of 15 transactions per block. Each queue updates the transaction feature every 3 seconds, a simulation time is 600 seconds, and a total of 40 blocks are generated.

Initially, interferences among all CBSDs may be calculated based on transmission power and locations of the CBSDs, and an interference overlap graph is constructed to allocate initial wireless resources.

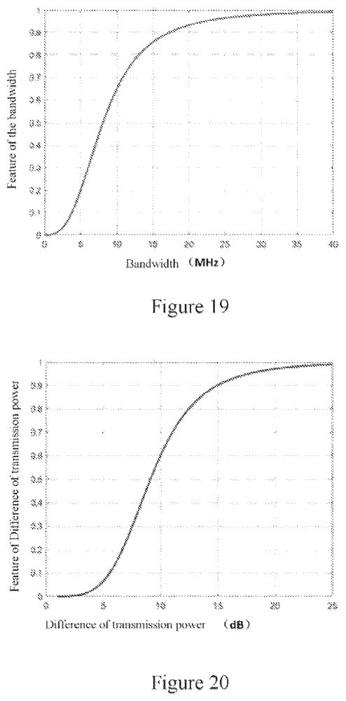

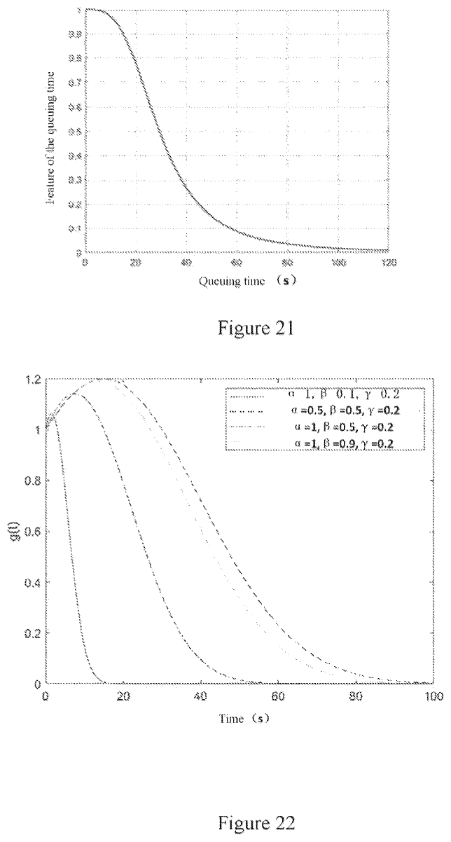

FIG. 18 to FIG. 21 show utility functions of different parameters. Specifically, FIG. 18 shows a utility function of an impact (interference difference) on accumulated interferences of a primary system. FIG. 19 shows a utility function of a bandwidth. FIG. 20 shows a utility function of a difference of transmission power. FIG. 21 shows a utility function of a transaction queuing time. In the figures, an abscissa represents a range of a parameter, and an ordinate represents a utility value. According to a calculation equation for the utility value (as shown in equation (2)), a maximum value of the utility value is 1 and a minimum value of the utility value is 0. The curves are all S-shaped, determined by adjustable factors ηₓ and σₓ.

FIG. 22 shows a change of transaction feature update function (as shown in equation (12)) relative to a queuing time under different parameter values. In a case of the queuing time t=0, the value of the function is 1. The γ for each of the four curves has a value of 0.2, which determines that the maximum value of the transaction feature update function is 1.2, and the maximum value is achieved only when

$$t = m \cdot \frac{β}{α} \cdot {τ}_{block} .$$

The α has two values, i.e., 1 and 0.5, corresponding to a transaction feature loss factor in an urban hotspot scene and a transaction feature loss factor in a suburban scene, respectively. The β has a value of 0.1, 0.5, 0.5, and 0.9, corresponding to different transaction feature compensation factors, respectively. It can be found from the changing trends of the four curves that a greater value of β/α results in a greater width of the curve, and thereby a longer time for which a transaction feature can be remained greater than or equal to an initial value, and a longer time for which the corresponding transaction can be queued in the transaction pool, that is, resulting in a more apparent compensation for the transaction feature. On the contrary, a smaller β/α results in a quick decrease of the curve, and thereby a shorter time for which the transaction can be queued in the transaction pool, that is, resulting in a more apparent loss of the transaction feature.

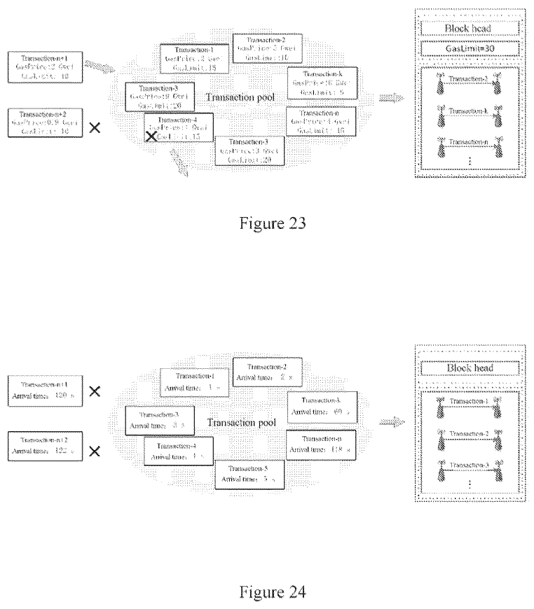

In order to compare with the solution of the present disclosure, the following simulations are further performed to simulate situations of using an existing transaction fee-based queuing method and a first-come-first-served (FCFS)-based queuing method. FIG. 23 shows a schematic diagram of a transaction fee-based queuing method. In Bitcoin and Ethereum blockchains, a transaction queuing mechanism based on transaction fees (or GasPrice) is adopted, where GasLimit represents a limit on a block size. In a new block generation period, a processing node would select the transaction to be packaged from large to small according to the transaction fees, and is allowed to extract a part of the transaction fees as a processing fee according to certain rules, to incentivize the processing node. FIG. 24 shows a schematic diagram of a FCFS-based queuing method. In the Hyperledger Fabric blockchain, a transaction queuing mechanism based on FCFS is adopted. All transactions are processed in a chronological order of arrival time.

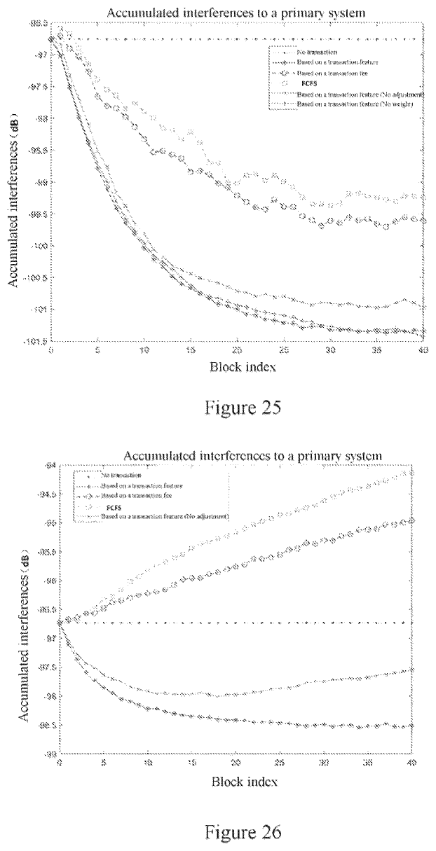

FIG. 25 shows a graph showing an impact on accumulated interferences of a primary system produced by a transaction for wireless resources with different queuing methods. 50 independent experiments are performed, and two transaction types (that is, bandwidth and power) are considered. In the graph, an abscissa axis represents an index of a block, and each block generation interval is 15 seconds, and therefore 40 blocks represent a simulation time of 600 seconds. An ordinate axis represents an average of the accumulated interferences on the primary system. In FIG. 25, comparison is made on changes in the accumulated interferences of the primary system in the following six situations: no transaction of wireless resources (as a reference); the queuing method based on the transaction feature proposed by the present disclosure (including dynamically adjusting the transaction feature and setting a weight for the queue); the above-mentioned queuing method based on a transaction fee; the above-mentioned queuing method based on FCFS; the queuing method based on the transaction feature proposed by the present disclosure (excluding dynamically adjusting the transaction feature); and the queuing method based on the transaction feature proposed by the present disclosure (excluding setting a weight for the queue). As can be seen generally, the transaction of wireless resources reduces the accumulated interferences to the primary system. A main reason includes a change in interference relationships caused by the transaction of wireless resources and a reduction in the power of some nodes caused by the transaction of power. It can be seen from the comparison of the simulation curves in FIG. 25 that in terms of reducing the accumulated interferences on the primary system, the queuing method based on transaction fees and the queuing method based on FCFS are not as effective as the queuing method based on the transaction feature proposed in the present disclosure.

FIG. 26 shows another graph of an impact on accumulated interferences of a primary system produced by a transaction for wireless resources under different queuing methods. 50 independent experiments are performed, and only transactions of bandwidth are considered. In the graph, an abscissa axis represents an index of a block, and each block generation interval is 15 seconds, and therefore 40 blocks represent a simulation time of 600 seconds. An ordinate axis represents an average of the accumulated interferences of the primary system. It can be seen that the three queuing methods based on the transaction feature of the present disclosure can all effectively reduce the accumulated interferences to the primary system, and the reduction is more apparent when considering the dynamic adjustment of the transaction feature. The accumulated interferences are increased with the method based on transaction fees or the method based on FCFS. Therefore, with the solution proposed in the present disclosure, spectrum transaction can be effectively utilized and the accumulated interferences to the primary system can be optimized. In addition, it can be determined that in the simulation shown in FIG. 25, for the transaction fee-based method and the FCFS-based method, a factor that reduces the accumulated interferences to the primary system is mainly the transaction of power.

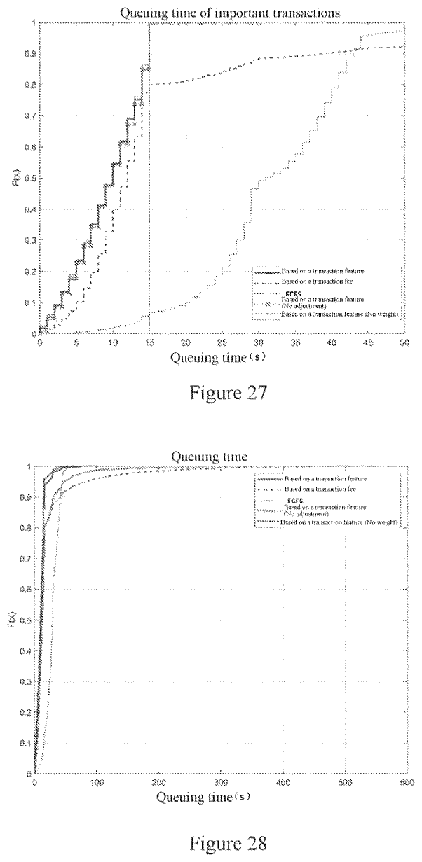

FIG. 27 shows a graph of a cumulative distribution of a queuing time for an important transaction under different queuing methods. 50 independent experiments are performed. In the graph, an abscissa represents a queuing time, where processing of important transactions within 0 to 100 seconds are mainly examined; and an ordinate represents a cumulative distribution of the queuing time. It can be seen that with the queuing method proposed by the present disclosure, almost all the important transactions are completed within 15 seconds (one block generation period). In contrast, the queuing methods based on the transaction feature without setting a weight for the queue according to the present disclosure are similar in performance, while the other three queuing methods have longer queuing time for important transactions. Therefore, the queuing method proposed in the present disclosure can effectively reduce the queuing time for an important transaction.

FIG. 28 shows a graph of a cumulative distribution of a queuing time for all transactions under different queuing methods. 50 independent experiments are performed. In the graph, an abscissa represents a queuing time, where processing of all transactions within 0 to 600 seconds are mainly examined; and an ordinate represents a cumulative distribution of the queuing time. It can be seen that with the queuing method based on the transaction feature proposed in the present disclosure (including dynamically adjusting the transaction feature), transactions are not accumulated in the transaction pool. In contrast, the queuing method based on the transaction feature without considering the dynamic adjustment of the transaction feature and the queuing method based on transaction fees cause accumulation of transactions. The queuing method based on FCFS focuses on fairness, but the processing time of most transactions is long. Therefore, it can be proved that the queuing method based on the transaction feature proposed by the present disclosure can prevent accumulation of transactions in the transaction pool and realize a high processing speed.

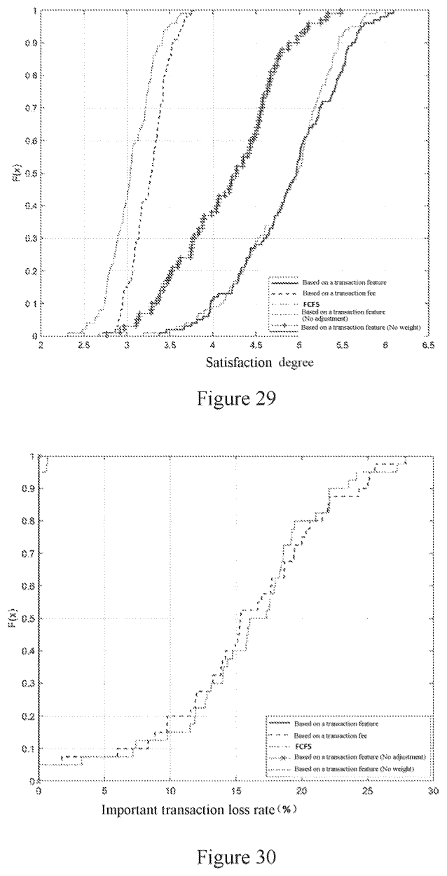

FIG. 29 shows a graph of a cumulative distribution of node satisfaction degree under different queuing modes. In the graph, an abscissa axis represents a satisfaction degree of 100 nodes. In the simulation, an average satisfaction degree of each node under 50 independent experiments is first counted, and then a cumulative distribution curve is drawn. The curve being closer to the right indicates a better satisfaction degree performance of the corresponding solution. It can be seen that in the transaction feature-based queuing method (including setting a weight for the queue) proposed in the present disclosure, the cumulative distribution of the satisfaction is better than the transaction fee-based queuing method and the FCFS-based queuing method, and is also better than the case without setting a weight for the queue. Therefore, the queuing method based on the transaction feature proposed in the present disclosure can effectively improve the satisfaction degree of the node, and can further improve the satisfaction degree of the node when a weight is set for the queue.

FIG. 30 shows a graph of a cumulative distribution of an important transaction loss rate under different queuing methods. In the graph, an abscissa axis represents a probability of transaction loss. In the simulation, 50 independent experiments are performed, a total number of occurrences of important transactions in each block generation period is counted, and a total number of important transactions that are lost due to insufficient capacity of a transaction pool in each block generation period is counted. A ratio of the two is a loss probability. It can be seen that the loss rate of important transactions in the queuing method (including setting a weight for the queue) based on the transaction feature proposed by the present disclosure is almost 0, while the loss rate of important transactions in the queuing mechanism based on transaction fees or FCFS is mostly between 15% and 30%. Therefore, the queuing method based on the transaction feature proposed in the present disclosure can better ensure that an important transaction enters a transaction pool when a capacity of the transaction pool is insufficient.

The technology of the present disclosure may be applied to various products. For example, the electronic apparatuses 100 or 200 each may be implemented as any type of servers, such as a tower server, a rack server or a blade server. The electronic apparatus 100 or 200 may be a control module installed on a server (such as an integrated circuit module including a single wafer, and a card or blade inserted into a slot of a blade server).

The electronic apparatus 300 or 400 may be implemented as various base stations. The base stations may be implemented as any type of evolved node B (eNB) or gNB (5G base station). The eNB includes for example a macro eNB and a small eNB. The small eNB may be an eNB covering a cell smaller than a macro cell, such as a pico eNB, a micro eNB and a home (femto) eNB. For gNB, the case may also be similar to that for eNB. Alternatively, the base station may also be implemented as any other type of base stations, such as a NodeB and a base transceiver station (BTS). The base station may include a main body (also referred to as a base station apparatus) configured to control wireless communications, and one or more remote radio heads (RRH) arranged in a different place from the main body. In addition, various types of user equipment may each operate as the base station by temporarily or semi-persistently executing a base station function. [Application examples regarding a server]

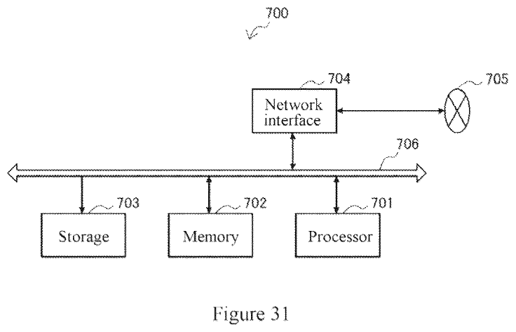

FIG. 31 is a block diagram showing an example of a schematic configuration of a server 700 to which the technology according to the present disclosure may be applied. The server 700 includes a processor 701, a memory 702, a storage 703, a network interface (I/F) 704, and a bus 706.

The processor 701 may be, for example, a central processing unit (CPU) or a digital signal processor (DSP), and control a function of the server 700. The memory 702 includes a random access memory (RAM) and a read only memory (ROM), and stores data and a program executed by the processor 701. The storage 703 may include a storage medium, such as a semiconductor memory and a hard disk.

The network interface 704 is a wired communication interface for connecting the server 700 to a wired communication network 705. The wired communication network 705 may be a core network such as an evolved packet core network (EPC) or a packet data network (PDN) such as the Internet.

The bus 706 connects the processor 701, the memory 702, the storage 703 and the network interface 704 to each other. The bus 706 may include two or more buses having different speeds (such as a high-speed bus and a low-speed bus).

In the server 700 shown in FIG. 31, the calculation unit 101, the generation unit 102 and the communication unit 103 described with reference to FIG. 2 and the communication unit 201 and the calculation unit 202 described with reference to FIG. 5 may be implemented by the processor 701. For example, the processor 701 can implement the calculation of the transaction feature and the endorsement of the transaction by executing the functions of the calculation unit 101, the generation unit 102 and the communication unit 103, and can calculate the interference impact to be produced by the transaction on accumulated interferences a primary system is subjected to by executing the functions of the communication unit 201 and the calculation unit 202.

### [Application Example Regarding a Base Station]

### (First Application Example)

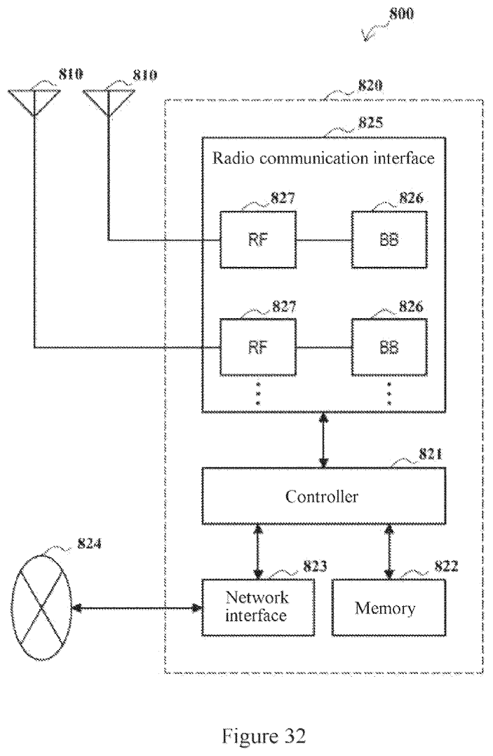

FIG. 32 is a block diagram showing a first example of an exemplary configuration of an eNB or gNB to which technology according to the present disclosure may be applied. It should be noted that the following description is given by taking the eNB as an example, which is also applicable to the gNB. An eNB 800 includes one or more antennas 810 and a base station apparatus 820. The base station apparatus 820 and each of the antennas 810 may be connected to each other via an RF cable.

Each of the antennas 810 includes a single or multiple antennal elements (such as multiple antenna elements included in a multiple-input multiple-output (MIMO) antenna), and is used for the base station apparatus 820 to transmit and receive wireless signals. As shown in FIG. 32, the eNB 800 may include the multiple antennas 810. For example, the multiple antennas 810 may be compatible with multiple frequency bands used by the eNB 800. Although FIG. 32 shows the example in which the eNB 800 includes the multiple antennas 810, the eNB 800 may also include a single antenna 810.

The base station apparatus 820 includes a controller 821, a memory 822, a network interface 823, and a radio communication interface 825.

The controller 821 may be, for example, a CPU or a DSP, and operates various functions of a higher layer of the base station apparatus 820. For example, the controller 821 generates a data packet from data in signals processed by the radio communication interface 825, and transfers the generated packet via the network interface 823. The controller 821 may bundle data from multiple base band processors to generate the bundled packet, and transfer the generated bundled packet. The controller 821 may have logical functions of performing control such as radio resource control, radio bearer control, mobility management, admission control and scheduling. The control may be performed in corporation with an eNB or a core network node in the vicinity. The memory 822 includes a RAM and a ROM, and stores a program executed by the controller 821 and various types of control data (such as terminal list, transmission power data and scheduling data).

The network interface 823 is a communication interface for connecting the base station apparatus 820 to a core network 824. The controller 821 may communicate with a core network node or another eNB via the network interface 823. In this case, the eNB 800, and the core network node or another eNB may be connected to each other via a logic interface (such as an S1 interface and an X2 interface). The network interface 823 may also be a wired communication interface or a wireless communication interface for wireless backhaul. If the network interface 823 is a wireless communication interface, the network interface 823 may use a higher frequency band for wireless communication than that used by the radio communication interface 825.

The radio communication interface 825 supports any cellular communication scheme (such as Long Term Evolution (LTE) and LTE-advanced), and provides wireless connection to a terminal located in a cell of the eNB 800 via the antenna 810. The radio communication interface 825 may typically include, for example, a baseband (BB) processor 826 and an RF circuit 827. The BB processor 826 may perform, for example, encoding/decoding, modulating/demodulating, and multiplexing/demultiplexing, and performs various types of signal processing of layers (such as L1, Media Access Control (MAC), Radio Link Control (RLC), and a Packet Data Convergence Protocol (PDCP)). The BB processor 826 may have a part or all of the above-described logical functions instead of the controller 821. The BB processor 826 may be a memory storing communication control programs, or a module including a processor and a related circuit configured to execute the programs. Updating the program may allow the functions of the BB processor 826 to be changed. The module may be a card or a blade that is inserted into a slot of the base station apparatus 820. Alternatively, the module may also be a chip that is mounted on the card or the blade. Meanwhile, the RF circuit 827 may include, for example, a mixer, a filter, and an amplifier, and transmits and receives wireless signals via the antenna 810.

As shown in FIG. 32, the radio communication interface 825 may include the multiple BB processors 826. For example, the multiple BB processors 826 may be compatible with multiple frequency bands used by the eNB 800. The radio communication interface 825 may include multiple RF circuits 827, as shown in FIG. 32. For example, the multiple RF circuits 827 may be compatible with multiple antenna elements. Although FIG. 32 shows the example in which the radio communication interface 825 includes the multiple BB processors 826 and the multiple RF circuits 827, the radio communication interface 825 may also include a single BB processor 826 or a single RF circuit 827.

In the eNB 800 shown in FIG. 32, the communication unit 302 and the transceiver of the electronic apparatus 300 described with reference to FIG. 6 may be implemented by the radio communication interface 825. At least a part of the functions may be implemented by the controller 821. For example, the controller 821 may implement the endorsement of the transaction and the acquisition of the transaction feature by executing the functions of the generation unit 301 and the communication unit 302. The communication unit 401 and the transceiver of the electronic apparatus 400 described with reference to FIG. 8 may be implemented by the radio communication interface 825. At least a part of the functions may be implemented by the controller 821. For example, the controller 821 may implement a blockchain-based transaction management with the transaction feature by executing the functions of the communication unit 401 and the blockchain unit 402. (Second Application Example)

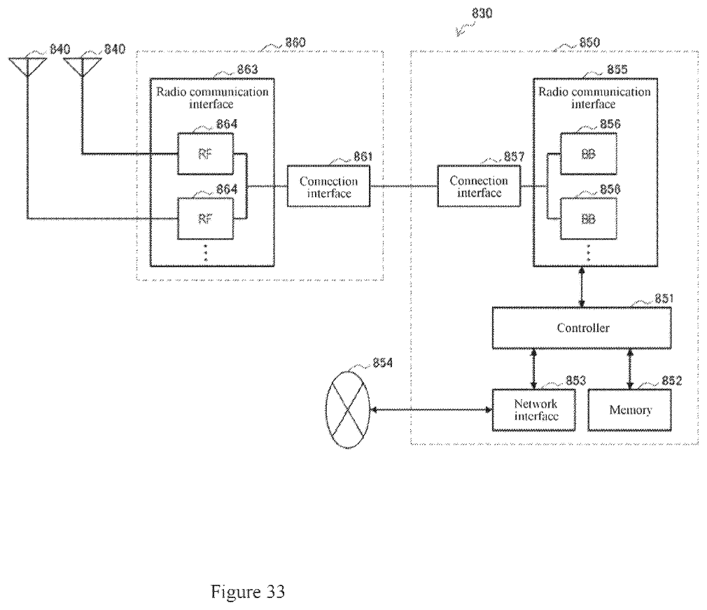

FIG. 33 is a block diagram showing a second example of the exemplary configuration of an eNB or gNB to which the technology according to the present disclosure may be applied. It should be noted that the following description is given by taking the eNB as an example, which is also applied to the gNB. An eNB 830 includes one or more antennas 840, a base station apparatus 850, and an RRH 860. The RRH 860 and each of the antennas 840 may be connected to each other via an RF cable. The base station apparatus 850 and the RRH 860 may be connected to each other via a high velocity line such as an optical fiber cable.

Each of the antennas 840 includes a single or multiple antennal elements (such as multiple antenna elements included in an MIMO antenna), and is used for the RRH 860 to transmit and receive wireless signals. As shown in FIG. 33, the eNB 830 may include the multiple antennas 840. For example, the multiple antennas 840 may be compatible with multiple frequency bands used by the eNB 830. Although FIG. 33 shows the example in which the eNB 830 includes the multiple antennas 840, the eNB 830 may also include a single antenna 840.

The base station apparatus 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 32.

The radio communication interface 855 supports any cellular communication scheme (such as LTE and LTE-advanced), and provides wireless communication to a terminal located in a sector corresponding to the RRH 860 via the RRH 860 and the antenna 840. The radio communication interface 855 may typically include, for example, a BB processor 856. The BB processor 856 is the same as the BB processor 826 described with reference to FIG. 32, except that the BB processor 856 is connected to an RF circuit 864 of the RRH 860 via the connection interface 857. As show in FIG. 33, the radio communication interface 855 may include the multiple BB processors 856. For example, the multiple BB processors 856 may be compatible with multiple frequency bands used by the eNB 830. Although FIG. 33 shows the example in which the radio communication interface 855 includes the multiple BB processors 856, the radio communication interface 855 may also include a single BB processor 856.

The connection interface 857 is an interface for connecting the base station apparatus 850 (radio communication interface 855) to the RRH 860. The connection interface 857 may also be a communication module for communication in the above-described high velocity line that connects the base station apparatus 850 (radio communication interface 855) to the RRH 860.

The RRH 860 includes a connection interface 861 and a radio communication interface 863.

The connection interface 861 is an interface for connecting the RRH 860 (radio communication interface 863) to the base station apparatus 850. The connection interface 861 may also be a communication module for communication in the above-described high velocity line.

The radio communication interface 863 transmits and receives wireless signals via the antenna 840. The radio communication interface 863 may typically include, for example, the RF circuit 864. The RF circuit 864 may include, for example, a mixer, a filter and an amplifier, and transmits and receives wireless signals via the antenna 840. The radio communication interface 863 may include multiple RF circuits 864, as shown in FIG. 33. For example, the multiple RF circuits 864 may support multiple antenna elements. Although FIG. 33 shows the example in which the radio communication interface 863 includes the multiple RF circuits 864, the radio communication interface 863 may also include a single RF circuit 864.

In the eNB 830 shown in FIG. 33, the communication unit 302 and the transceiver of the electronic apparatus 300 described with reference to FIG. 6 may be implemented by the radio communication interface 855 and/or the radio communication interface 863. At least a part of the functions may be implemented by the controller 851. For example, the controller 851 may implement the endorsement of the transaction and the acquisition of transaction feature by executing the functions of the generation unit 301 and the communication unit 302. The communication unit 401 and the transceiver of the electronic apparatus 400 described with reference to FIG. 8 may be implemented by the radio communication interface 855 and/or the radio communication interface 863. At least a part of the functions may be implemented by the controller 851. For example, the controller 851 may implement a blockchain-based transaction management with the transaction feature by executing the functions of the communication unit 401 and the blockchain unit 402.

The basic principle of the present disclosure has been described above in conjunction with particular embodiments. However, as can be appreciated by those ordinarily skilled in the art, all or any of the steps or components of the method and apparatus according to the disclosure can be implemented with hardware, firmware, software or a combination thereof in any computing device (including a processor, a storage medium, etc.) or a network of computing devices by those ordinarily skilled in the art in light of the disclosure of the disclosure and making use of their general circuit designing knowledge or general programming skills.

Moreover, the present disclosure further discloses a program product in which machine-readable instruction codes are stored. The aforementioned methods according to the embodiments can be implemented when the instruction codes are read and executed by a machine.

Accordingly, a memory medium for carrying the program product in which machine-readable instruction codes are stored is also covered in the present disclosure. The memory medium includes but is not limited to soft disc, optical disc, magnetic optical disc, memory card, memory stick and the like.

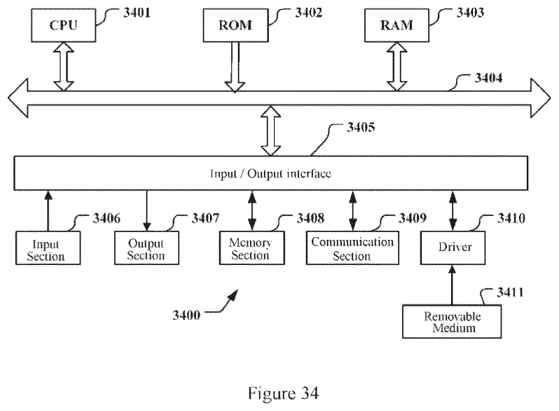

In the case where the present disclosure is realized with software or firmware, a program constituting the software is installed in a computer with a dedicated hardware structure (e.g. the general computer 3400 shown in FIG. 34) from a storage medium or network, wherein the computer is capable of implementing various functions when installed with various programs.

In FIG. 34, a central processing unit (CPU) 3401 executes various processing according to a program stored in a read-only memory (ROM) 3402 or a program loaded to a random access memory (RAM) 3403 from a memory section 3408. The data needed for the various processing of the CPU 3401 may be stored in the RAM 3403 as needed. The CPU 3401, the ROM 3402 and the RAM 3403 are linked with each other via a bus 3404. An input/output interface 3405 is also linked to the bus 3404.

The following components are linked to the input/output interface 3405: an input section 3406 (including keyboard, mouse and the like), an output section 3407 (including displays such as a cathode ray tube (CRT), a liquid crystal display (LCD), a loudspeaker and the like), a memory section 3408 (including hard disc and the like), and a communication section 3409 (including a network interface card such as a LAN card, modem and the like). The communication section 3409 performs communication processing via a network such as the Internet. A driver 3410 may also be linked to the input/output interface 3405, if needed. If needed, a removable medium 3411, for example, a magnetic disc, an optical disc, a magnetic optical disc, a semiconductor memory and the like, may be installed in the driver 3410, so that the computer program read therefrom is installed in the memory section 3408 as appropriate.

In the case where the foregoing series of processing is achieved through software, programs forming the software are installed from a network such as the Internet or a memory medium such as the removable medium 3411.

It should be appreciated by those skilled in the art that the memory medium is not limited to the removable medium 3411 shown in FIG. 34, which has program stored therein and is distributed separately from the apparatus so as to provide the programs to users. The removable medium 3411 may be, for example, a magnetic disc (including floppy disc (registered trademark)), a compact disc (including compact disc read-only memory (CD-ROM) and digital versatile disc (DVD), a magneto optical disc (including mini disc (MD)(registered trademark)), and a semiconductor memory. Alternatively, the memory medium may be the hard discs included in ROM 3402 and the memory section 3408 in which programs are stored, and can be distributed to users along with the device in which they are incorporated.

To be further noted, in the apparatus, method and system according to the present disclosure, the respective components or steps can be decomposed and/or recombined. These decompositions and/or re-combinations shall be regarded as equivalent solutions of the disclosure. Moreover, the above series of processing steps can naturally be performed temporally in the sequence as described above but will not be limited thereto, and some of the steps can be performed in parallel or independently from each other.

Finally, to be further noted, the term “include”, “comprise” or any variant thereof is intended to encompass nonexclusive inclusion so that a process, method, article or device including a series of elements includes not only those elements but also other elements which have been not listed definitely or an element(s) inherent to the process, method, article or device. Moreover, the expression “comprising a(n) . . . ” in which an element is defined will not preclude presence of an additional identical element(s) in a process, method, article or device comprising the defined element(s)” unless further defined.

Although the embodiments of the present disclosure have been described above in detail in connection with the drawings, it shall be appreciated that the embodiments as described above are merely illustrative rather than limitative of the present disclosure. Those skilled in the art can make various modifications and variations to the above embodiments without departing from the spirit and scope of the present disclosure. Therefore, the scope of the present disclosure is defined merely by the appended claims and their equivalents.

1. An electronic apparatus for wireless communications, comprising:
at least one processor; and
at least one memory including computer program code, where the at least one memory and the computer program code are configured, with the at least one processor, to cause the electronic apparatus to:
calculate, in response to a transaction endorsement request from a buyer node of a transaction for wireless resources, a transaction feature of the transaction based on an interference impact on accumulated interferences a primary system is subjected to and a performance impact on network performance to be produced by the transaction;
generate, at least based on the transaction feature, a transaction endorsement response; and
transmit the transaction endorsement response to the buyer node.

2. The electronic apparatus according to claim 1, wherein the transaction endorsement request comprises one or more of the following: basic information of the buyer node, a measurement report of a wireless environment measurement performed by the buyer node for the transaction, an expected transmission parameter of the buyer node, a transmission parameter of a seller node, a geographical location of the buyer node, a geographical location of the seller node, a transaction frequency band, a transaction type, a transaction volume and a service type, and
wherein the transaction type comprises information indicating a type of wireless resources for transaction, and the transaction type comprises one or more of the following: bandwidth, and power.

3. (canceled)

4. The electronic apparatus according to claim 1, wherein the at least one memory and the computer program code are further configured, with the at least one processor, to cause the electronic apparatus to: transmit an interference validation request to a spectrum access system, so that the spectrum access system calculates the interference impact based on the interference validation request; and receive an interference validation response from the spectrum access system,
wherein, the interference validation request comprises at least part information in the transaction endorsement response, and the interference validation response comprises information of the calculated interference impact.

5. The electronic apparatus according to claim 4, wherein the buyer node is a citizens broadband radio service device, and the electronic apparatus is on a coexistence manager.

6. The electronic apparatus according to claim 1, wherein the at least one memory and the computer program code are configured, with the at least one processor, to cause the electronic apparatus to calculate the performance impact based on a transaction type and transaction volume of the transaction, and calculate the transaction feature based on a weighted sum of a utility function of the performance impact and a utility function of the interference impact.

7. The electronic apparatus according to claim 6, wherein the at least one memory and the computer program code are further configured, with the at least one processor, to cause the electronic apparatus to determine respective weights of the utility function of the performance impact and the utility function of the interference impact based on one or more of the following: an application scenario of the buyer node, an interference status of the primary system.

8. The electronic apparatus according to claim 1, wherein the at least one memory and the computer program code are further configured, with the at least one processor, to cause the electronic apparatus determine a dynamic adjustment parameter of the transaction feature based on the transaction endorsement request and contain the dynamic adjustment parameter in the transaction endorsement response, the dynamic adjustment parameter being used for dynamically adjusting the transaction feature during a queuing procedure of the transaction, and
wherein the dynamic adjustment parameter comprises a transaction feature loss factor and/or a transaction feature compensation factor, wherein the transaction feature loss factor is for considering a transaction feature loss caused by a user equipment mobility and transaction processing delay, and the transaction feature compensation factor is for compensating for a transaction feature loss caused by a transaction queuing time.

9. (canceled)

10. The electronic apparatus according to claim 8, wherein the transaction feature loss factor depends on a geographical location of the buyer node, and the transaction feature compensation factor depends on a historical transaction status of the buyer node.

11. The electronic apparatus according to claim 1, wherein the transaction feature represents a priority level for processing the transaction; and/or
wherein the at least one memory and the computer program code are further configured, with the at least one processor, to cause the electronic apparatus to receive a transaction request from the buyer node before receiving the transaction endorsement request from the buyer node, query for wireless resources and a seller node available for transaction in response to the transaction request, and transmit information of the wireless resource and seller node available for transaction to the buyer node as a transaction response, wherein the transaction request comprises a transaction type and/or a service type; and/or
receive a registration request from a transaction node and transmit a registration response to the transaction node, wherein the registration request comprises an indication that the transaction node supports a wireless resource transaction function and/or that the transaction node supports a wireless resource transaction processing function.

12.-13. (canceled)

14. An electronic apparatus for wireless communications, comprising:
at least one processor; and
at least one memory including computer program code, where the at least one memory and the computer program code are configured, with the at least one processor, to cause the electronic apparatus to:
generate a transaction endorsement request for a transaction of wireless resources;
transmit the transaction endorsement request to a spectrum management device; and
receive, from the spectrum management device, a transaction endorsement response to the transaction endorsement request, wherein the transaction endorsement response comprises a transaction feature of the transaction, and the transaction feature is calculated by the spectrum management device based on an interference impact on accumulated interferences a primary system is subjected to and a performance impact on network performance to be produced by the transaction.

15.-16. (canceled)

17. The electronic apparatus according to claim 14, wherein the at least one memory and the computer program code are further configured, with the at least one processor, to cause the electronic apparatus to transmit a transaction request to the spectrum management device before generating the transaction endorsement request, and receive a transaction response from the spectrum management device, wherein the transaction request comprises a transaction type and/or a service type, the spectrum management device queries for wireless resources and a seller node available for transaction in response to the transaction request, and contains information of the wireless resource and seller node available for transaction in the transaction response.

18. The electronic apparatus according to claim 17, wherein the at least one memory and the computer program code are further configured, with the at least one processor, to cause the electronic apparatus to perform a wireless environment measurement related to the transaction type based on the transaction response.

19.-20. (canceled)

21. The electronic apparatus according to claim 14, wherein the at least one memory and the computer program code are configured, with the at least one processor, to cause the electronic apparatus to broadcast an endorsed transaction to a processing node in a network that supports the wireless resource transaction processing function, wherein the endorsed transaction comprises the transaction feature,
wherein, the processing node maintains a transaction pool and processes transactions in the transaction pool based on a blockchain technology.

22.-23. (canceled)

24. The electronic apparatus according to claim 21, wherein the at least one memory and the computer program code are further configured, with the at least one processor, to cause the electronic apparatus to receive a block from a processing node obtaining block generation authorization, and obtain a processing result of the transaction for the present node by parsing the block.

25. An electronic apparatus for wireless communications, comprising:
at least one processor; and
at least one memory including computer program code, where the at least one memory and the computer program code are configured, with the at least one processor, to cause the electronic apparatus to:
receive an endorsed transaction for wireless resources which comprises a transaction feature of the transaction, the transaction feature being calculated by a spectrum management device based on an interference impact on accumulated interferences a primary system is subjected to and a performance impact on network performance to be produced by the transaction; and
add the received transaction as a new transaction into a transaction pool maintained based on a blockchain technology.

26. The electronic apparatus according to claim 25, wherein the at least one memory and the computer program code are configured, with the at least one processor, to cause the electronic apparatus to maintain a separate transaction queue for each of a plurality of application scenarios, and determine a transaction queue to which the new transaction is to be added based on a scenario which the new transaction is with respect to, and
wherein the application scenarios comprise: eMBB, mMTC and URLLC.

27. (canceled)

28. The electronic apparatus according to claim 26, wherein the at least one memory and the computer program code are further configured, with the at least one processor, to cause the electronic apparatus to determine whether to add the new transaction based on a transaction feature of the new transaction, in a case that a capacity of the transaction queue is insufficient; and
substitute the new transaction for a transaction with a lowest transaction feature in the transaction queue to which the new transaction is to be added, in a case that the following condition is satisfied: an interference utility value related to the interference impact in the transaction feature of the new transaction being greater than 0; and the transaction feature of the new transaction being higher than the transaction feature of the transaction with the lowest transaction feature.

29. (canceled)

30. The electronic apparatus according to claim 26, wherein the at least one memory and the computer program code are further configured, with the at least one processor, to cause the electronic apparatus to periodically update the transaction feature of each transaction in each transaction queue, and dynamically adjust the transaction queue based on the updated transaction feature,
wherein the endorsed transaction further comprises a dynamic adjustment parameter of the transaction, and the at least one memory and the computer program code are configured, with the at least one processor, to cause the electronic apparatus to update the transaction feature of the transaction based on the dynamic adjustment parameter, a queuing time, and a block generation time, and
wherein the at least one memory and the computer program code are configured, with the at least one processor, to cause the electronic apparatus to reorder transactions in the transaction queue based on magnitudes of the updated transaction feature and remove a transaction whose transaction feature falls below a predetermined threshold.

31.-32. (canceled)

33. The electronic apparatus according to claim 26, wherein the at least one memory and the computer program code are configured, with the at least one processor, to cause the electronic apparatus to
obtain block generation authorization through consensus at a new block generation timing, and select and package transactions with high transaction features from among the respective transaction queues to form a new block,
determine, based on a weight of each transaction queue, a number of transactions to be selected from among the transaction queue, and
determine a weight of each transaction queue based on one or more of the following: a sum of transaction features of transactions in each transaction queue, and an importance factor of each transaction queue.

34.-37. (canceled)

38. The electronic apparatus according to claim 25, wherein the at least one memory and the computer program code are further configured, with the at least one processor, to cause the electronic apparatus to calculate a transaction satisfaction degree based on execution conditions of transactions in the transaction pool.

39.-45. (canceled)
